(19) United States
(12) Patent Application Publication
(10) Pub. No.: US 2009/0035664 A1
(43) Pub. Date: Feb. 5, 2009

(54) BATTERIES AND ELECTRODES FOR USE THEREOF

(75) Inventors: Yet-Ming Chiang, Framingham, MA (US); Ryan C. Wartena, Los Angeles, CA (US); Timothy E. Chin, Cambridge, MA (US); Can K. Erdonmez, Cambridge, MA (US); Wei Lai, Cambridge, MA (US)

Correspondence Address: WOLF GREENFIELD & SACKS, P.C., 600 ATLANTIC AVENUE, BOSTON, MA, 02210-2206, US

(73) Assignee: Massachusetts Institute of Technology, Cambridge, MA (US)

(21) Appl. No.: 12/126,841

(22) Filed: May 23, 2008

Related U.S. Application Data
(60) Provisional application No. 60/931,819, filed on May 25, 2007.

(51) Int. Cl. H01M 4/00; H01M 6/00; H01M 10/00; H01M 6/18

(52) U.S. Cl. 429/317; 429/209; 429/323; 429/322

(57) ABSTRACT

The present invention generally relates to batteries or other electrochemical devices, and systems and materials for use in these, including novel electrode materials and designs. In some embodiments, the present invention relates to small-scale batteries or microbatteries. For example, in one aspect of the invention, a battery may have a volume of no more than about 5 mm³, while having an energy density of at least about 400 W h/l. In some cases, the battery may include a electrode comprising a porous electroactive compound. In some embodiments, the pores of the porous electrode may be at least partially filled with a liquid such as a liquid electrolyte. The electrode may be able to withstand repeated charging and discharging. In some cases, the electrode may have a plurality of protrusions and/or a wall (which may surround the protrusions, if present); however, in other cases, there may be no protrusions or walls. The electrode may be formed from a unitary material. In certain embodiments, a nonporous electrolyte may be disposed onto the electrode. Such an electrolyte may allow ionic transport (e.g., of lithium ions) while preventing dendritic formation due to the lack of pores. In certain embodiments the porous electrode has a surface that is denser than its interior. Other aspects of the invention are directed to techniques of making such electrodes or batteries, techniques of forming electrical connections to and packaging such batteries, techniques of using such electrodes or batteries, or the like.

### RELATED APPLICATIONS

This application claims the benefit of U.S. Provisional Patent Application Ser. No. 60/931,819, filed May 25, 2007, by Chiang, et al., incorporated herein by reference.

### GOVERNMENT FUNDING

Research leading to various aspects of the present invention were sponsored, at least in part, by the U.S. Department of Defense, Grant No. 6895558. The U.S. Government may have certain rights in the invention.

### FIELD OF INVENTION

The present invention generally relates to batteries or other electrochemical devices, and systems and materials for use in these, including novel electrode materials and designs. In some embodiments, the present invention relates to small-scale batteries or microbatteries.

### BACKGROUND

Since the time of Volta, batteries and other electrochemical devices have been fabricated by the manual assembly of critical components. The advent of distributed and autonomous electronics requiring very small and high energy density power sources, as well as continuing demand in larger batteries for low cost energy and power, has created a need for entirely new designs and fabrication approaches for batteries and the like. Current devices range in length from micrometer-thick thin film batteries, to lithium rechargeable batteries based on wound laminate films, to the macroassemblies used in common alkaline and lead-acid batteries. However, the laminated construction techniques of current high energy density batteries (e.g., lithium ion batteries), now approaching their engineering limits, have inefficient mass and volume utilization, with only 30% to 40% of the available device volume being used for ion storage. Attempts to increase power density, for instance by using thinner electrodes, typically has come at the expense of energy density. Furthermore, as the size scale of powered devices continues to shrink, there is a growing need for distributed high energy density power sources of comparable size scale.

### SUMMARY OF THE INVENTION

The present invention generally relates to batteries or other electrochemical devices, and systems and materials for use in these, including novel electrode materials and designs. In some embodiments, the present invention relates to small-scale batteries or microbatteries. The subject matter of the present invention involves, in some cases, interrelated products, alternative solutions to a particular problem, and/or a plurality of different uses of one or more systems and/or articles.

In one aspect, the invention is directed to an article. In one set of embodiments, the article includes a battery comprising an entire anode, an electrolyte, and an entire cathode, where the battery has a volume of no more than about 5 mm³ or about 10 mm³ and an energy density of at least about 200 W h/l or at least about 400 W h/l. In another set of embodiments, the article includes a rechargeable battery having an energy density of at least about 1000 W h/l.

The article, in yet another set of embodiments, includes an electrode formed from a sintered ceramic and/or a ceramic composite, where the electrode has a porosity of no more than about 50%. In some cases, at least some of the pores of the electrode are filled with an electrolyte that is a liquid, a gel, a solid polymer, and/or a solid inorganic compound. In still another set of embodiments, the article includes an electrode formed from a sintered ceramic and/or a ceramic composite that is able to retain at least about 50% of its initial storage capacity after at least 6 charge-discharge cycles at a C/20 rate.

In one set of embodiments, the sintered electrode has a thickness of between 100 microns and 2000 microns and a porosity between 10% and 70% by volume, and more preferably a thickness between 300 microns and 1000 microns and porosity between 15% and 50% by volume.

In yet another set of embodiments, the article includes a electrode formed from a sintered ceramic or ceramic composite. The compound or compounds of the electrode may have, in some cases, a molar volume difference between the charged and discharged state of the cell of less than about 30%, less than about 15%, less than about 10%, or less than about 5%. In some embodiments the compound or compounds of the electrode has a linear or a volumetric strain between the charged and discharged state of the cell of less than about 20%, less than about 15%, less than about 10%, less than about 5%, less than about 3%, less than about 2%, or less than about 1%. In some embodiments, the compounds of the electrode include at least one compound that increases in molar volume at least some compositions during use and at least one compound that decreases in molar volume at least some compositions during use. In some embodiments, the net volume change of the electrode between the charged and discharged state of the battery is decreased by combining at least one compound that has a net positive volume change between the charged and discharged state, with at least one compound that has a net negative volume change between the charged and discharged state of the battery.

In one set of embodiments, the article includes an electrode formed from a sintered ceramic and/or a ceramic composite. The electrode may be micromachined in some cases. In some embodiments, the ceramic comprises a lithium metal oxide LiMO₂ where M is at least one transition metal, or a lithium transition metal phosphate olivine. In some embodiments, the sintered ceramic is LiCoO₂ and/or LiFePO₄. In another set of embodiments, the article includes a micromachined electrode formed from a porous sintered ceramic and/or a ceramic composite. In yet another set of embodiments, the article includes a micromachined electrode formed from a sintered ceramic and/or a ceramic composite, where the ceramic has a linear or a volumetric strain differential of less than about 20%, less than about 10%, less than about 3%, or less than about 2%.

The article, according to another set of embodiments, includes an electrode having a base and a plurality of protrusions extending at least about 50 micrometers away from the base of the electrode, where at least some of the protrusions comprising LiCoO₂, and where substantially all of the protrusions having a surface and a bulk and being sized such that substantially all of the bulk is no more than about 25 micrometers away from the surface. The electrode may be nonporous (dense) or porous. In some cases, the article may also include a nonporous electrolyte disposed on the surfaces of the protrusions.

According to yet another set of embodiments, the article includes an electrode comprising a base and a plurality of protrusions extending from the base, and a wall extending from the base and surrounding the plurality of protrusions. In some cases, the protrusions and the wall are formed from a unitary material. In another set of embodiments, the article includes an electrode comprising, on one surface, a plurality of protrusions and a wall surrounding the plurality of protrusions. In some cases, the electrode can be formed using laser micromachining.

According to yet another set of embodiments, the article includes a battery that comprises only solid phases. In another set of embodiments, the article includes a battery that comprises a liquid electrolyte. In another set of embodiments, the article includes a battery that comprises both a solid electrolyte and a liquid electrolyte.

In one set of embodiments, the article includes an electrode having a plurality of protrusions. In some cases, the protrusions have an aspect ratio of at least about 3:1 and a pitch of at least about 2:1. In one embodiment, the electrode is formed using laser micromachining. In another embodiment, the electrode is formed from a unitary material.

According to another set of embodiments, the article includes a lithium metal electrode, a nonporous electrolyte contacting the lithium metal electrode, and a porous sintered electrode contacting the lithium metal electrode.

Another aspect of the invention is drawn to a method. In one set of embodiments, the method includes an act of fabricating an electrode from a unitary material. In some cases, the electrode comprises, on one surface, a plurality of protrusions and a wall surrounding the plurality of protrusions.

In another set of embodiments, the method includes acts of providing a Li-containing substrate that Li metal will not wet, depositing a metal layer on the substrate, and adding Li metal to the metal layer. In some cases, the Li reacts with the metal layer to wet the surface.

In another aspect, the present invention is directed to a method of making one or more of the embodiments described herein, for example, a small-scale battery or a or microbattery. In another aspect, the present invention is directed to a method of using one or more of the embodiments described herein, for example, a small-scale battery or a microbattery.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D illustrate electrodes having protrusions, according to one embodiment of the invention;

FIGS. 2A-2C are photomicrographs of an embodiment of the invention, illustrating an electrode having ribs;

FIG. 3 illustrates a sloped protrusion, in accordance with one embodiment of the invention;

FIGS. 4A-4C are photomicrographs of various embodiments of the invention having sloped protrusions;

FIGS. 5A-5B illustrate electrodes having walls, according to another embodiment of the invention;

FIGS. 6A-6E are photomicrographs of various embodiments of the invention, illustrating electrodes having walls;

FIGS. 7A-7D are photomicrographs of another embodiment of the invention, illustrating an electrode having walls;

FIGS. 8A-8B are photomicrographs of yet another embodiment of the invention, illustrating electrodes having substantially planar surfaces;

FIGS. 9A-9C are photomicrographs of still another embodiment of the invention, illustrating an electrode that does not show any obvious degradation or cracking;

FIG. 10 is a schematic diagram of one embodiment of the invention;

FIG. 11 is a schematic diagram of a method of fabricating a battery, in accordance with another embodiment of the invention;

FIGS. 12A-12D illustrate an embodiment of the invention using colloidal-scale self-organization to produce an electrode;

FIGS. 13A-13B illustrate the energy densities of batteries using various materials, in accordance with certain embodiments of the invention;

FIG. 14 illustrates energy density as a function of volume for various batteries, in yet another embodiment of the invention;

FIGS. 15A-15B illustrate the deposition of liquid lithium on a wet oxide surface, in accordance with still another embodiment of the invention;

FIGS. 16A-16B show electrochemical test results of porous LiCoO₂ electrodes prepared in accordance with certain embodiments of the invention;

FIGS. 17A-17B show the specific capacity measured by galvanostatic cycling over 40 cycles of a sintered doped olivine phosphate cathode produced in accordance with one embodiment of the invention;

FIGS. 18A-18B show a conformal lithium phosphorus oxynitride layer sputtered onto a porous sintered LiCoO₂ cathode, in accordance with another embodiment of the invention;

FIG. 19 shows a galvanostatic test of a porous sintered LiCoO₂ cathode conformally coated with an approximately ˜0.5 micrometer thick film of lithium phosphorus oxynitride, in yet another embodiment of the invention;

FIGS. 20A-20B illustrates microbattery packaging comprising an electroformed gold can and copper foil lid, in still another embodiment of the invention;

FIG. 21 shows the first charge curve for two microbatteries made using sintered electrodes, in one embodiment of the invention;

FIG. 22 shows the first discharge curves for two microbatteries produced in accordance with another embodiment of the invention;

FIG. 23 shows the first four discharge curves for a microbattery produced in yet another embodiment of the invention, showing voltage vs. the specific capacity of the sintered LiCoO₂ cathode; and

FIGS. 24A-24C illustrate a bicell fabricated using sintered LiCoO₂ cathodes, and test results using the bicell, in still another embodiment of the invention.

### DETAILED DESCRIPTION

The present invention generally relates to batteries or other electrochemical devices, and systems and materials for use in these, including novel electrode materials and designs. In some embodiments, the present invention relates to small-scale batteries or microbatteries. For example, in one aspect of the invention, a battery may have a volume of no more than about 5 mm³ or about 10 mm³, while having an energy density of at least about 200 W h/l or at least about 400 W h/l. In some cases, the battery may include a electrode comprising a porous electroactive compound, for example, LiCoO₂, which may be formed, in some cases, by a process including but not limited to sintering of a particle compact. In some embodiments, the pores of the porous electrode may be at least partially filled with a liquid such as a liquid electrolyte comprising alkyl carbonates and/or a lithium salt such as LiPF₆, a polymer such as a polymer electrolyte comprising polyethylene oxide and/or a lithium salt, a block copolymer lithium-conducting electrolyte, and/or an inorganic electrolyte such as a lithium phosphorus oxynitride compound, lithium iodide, and the like. The electrode may be able to withstand repeated charging and discharging. In some cases, the electrode may have a plurality of protrusions and/or a wall (which may surround the protrusions, if present); however, in other cases, there may be no protrusions or walls present. The electrode may be formed from a unitary material, e.g., formed using laser micromachining, dry etching processes such as plasma or reactive ion etching, wet chemical etching, or similar techniques. In some instances, the electrode may be formed in a desired shape from a powder or powder suspension using methods such as tape-casting, interrupted tape-casting, slip-casting, pressing, and embossing, and may be fired to obtain a sintered material after forming. In certain embodiments, a nonporous electrolyte, such as lithium phosphorus oxynitride, a polymer electrolyte such as one based on polyethylene oxide and/or a lithium salt, a block-copolymer lithium conducting electrolyte, and/or a polyelectrolyte multilayer film (which may be formed by a layer-by-layer deposition process) may be disposed onto the electrode. Such an electrolyte may allow ionic transport (e.g., of lithium ions) while preventing dendritic formation due to the lack of pores. In certain embodiments the porous electrode has a surface that is denser than its interior. The denser surface may be formed by laser processing, rapid thermal annealing, formation of a surface layer with a higher powder particle packing density prior to sintering, filling of the surface with finer particles, application of a surface coating by a vapor phase deposition or a sol-gel coating process, or other such methods. Other aspects of the invention are directed to techniques of making such electrodes or batteries, techniques of forming electrical connections to and packaging such batteries, techniques of using such electrodes or batteries, or the like.

Various aspects of the invention are directed to batteries or other electrochemical devices. Generally, a battery includes an anode, a cathode, and an electrolyte separating the anode and the cathode. Current collectors may be electrically connected to the anode and the cathode, and current drawn from the battery using the current collectors. Typically, current is produced by the battery when the current collectors are put into electrical communication with each other, e.g., through a load, such as a light, a motor, an electrical circuit, a sensor, a transmitter, an electrical device, etc. Within the battery, ions flow through the electrolyte between the anode and the cathode during discharge. The electrolyte may be a solid, a liquid, a gel, or the like, and the electrolyte may be organic, inorganic, or a combination. In one aspect of the invention, the battery is a Li ion (Li⁺) battery, i.e., the battery uses Li⁺ as a charge carrier (alone, or in conjunction with other charge carriers) within the electrolyte.

In some embodiments, the battery is “dry,” meaning that it is substantially free of liquid or gel components. In other embodiments, however, the battery includes one or more liquid or gel electrolytes, which may fill or partially fill the interior of the battery cell. In some embodiments, the battery includes both solid and liquid electrolytes. For instance, in some cases, the solid electrolyte can be used as a conformal film coating the surface of an electrode, and/or as a separator between the electrodes.

In some cases, the battery is disposable after being discharged once. In other cases, however, the battery is rechargeable, i.e., the battery can be charged and discharged more than once. For example, the battery may be able to withstand at least 3 cycles, at least 6 cycles, or at least 10 cycles of charging and discharging (for example at a C/20 rate, where 1 C=280 mA/g) with a retention of its initial storage capacity (e.g., as measured in W h) of at least about 50%, at least about 60%, at least about 70%, at least about 75%, at least about 80%, at least about 85%, at least about 90%, or at least about 95% relative to the initial charge of the battery after its first full charging. A rechargeable lithium battery typically has electrodes that exchange lithium during charge and discharge. For a cathode or positive electrode material, Li⁺ and electrons are adsorbed during the discharge of the battery, and this process is reversed during the charge. Though the present invention is not limited to cathodes, as used herein, “charging” indicates lithium removal from the positive electrode and “discharging” refers to lithium insertion into the positive electrode.

In some embodiments of the present invention, the battery is a “microbattery,” i.e., a battery having a volume of less than about 10 mm³, including the entire anode, cathode, electrolyte, current collectors, and exterior packaging that form the battery. In some cases, the volume of the battery may be less than about 5 mm³, less than about 3 mm³, or less than about 1 mm³. For example, the battery may be generally cube-shaped, having dimensions of less than about 3 mm, less than about 2.5 mm, less than about 2 mm, less than about 1.5 mm, or less than about 1 mm on each side. Of course, other shapes are also possible, for example, rectangular parallelepiped, disc, rod, plate, or spherical shapes, in other embodiments of the invention. In some embodiments of the invention, the battery may contain an electrode having a smallest dimension of at least about 0.2 mm, and in some cases, at least about 0.4 mm, at least about 0.6 mm, at least about 0.8 mm, at least about 1.0 mm, at least about 1.5 mm, or at least about 2.0 mm.

In some embodiments, the battery may have a volume, mass, energy, and/or power suitable for use in portable electronic devices such as wireless headsets (e.g., Bluetooth), cellular telephones, laptop computers, cordless power tools or other appliances, vehicles, backup power systems, or in large scale energy storage systems.

In one set of embodiments, the battery has an energy density of at least about 200 W h/l, i.e., the battery is able to produce 200 W h of energy for each liter of volume of the battery (including the entire anode, cathode, and electrolyte forming the battery). In some embodiments, even higher energy densities can be obtained, for instance, at least about 300 W h/l, at least about 400 W h/l, at least about 800 W h/l, at least about 1000 W h/l, at least about 1200 W h/l, at least about 1400 W h/l, or at least about 1600 W h/l. In other such embodiments, such energy densities can be obtained even when the current collector and packaging of the cell are included in the battery volume.

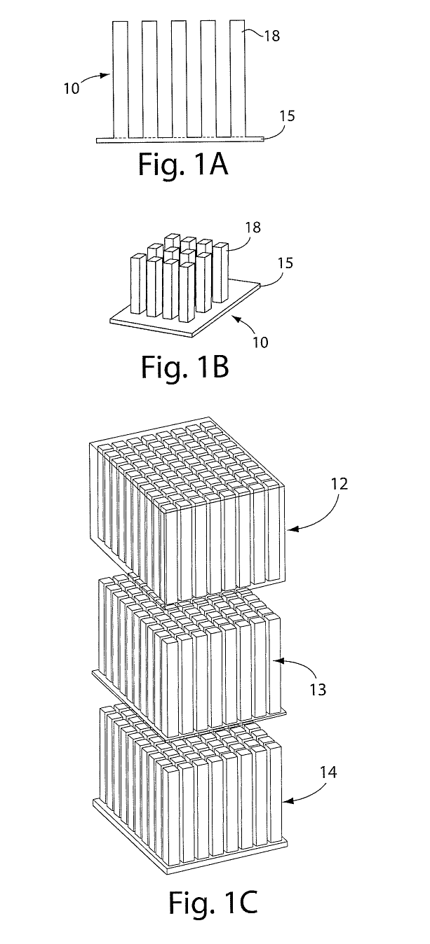

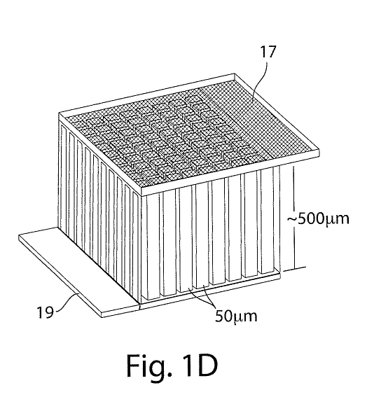

In one aspect of the present invention, such energy densities may be achieved by using a cathode having a shape such that substantially all of the cathode may be able to participate in lithium ion exchange, e.g., with the electrolyte during charge or discharge. For instance, in some embodiments, the electrode has a shape that allows a relatively high degree of exposure between the electrode and the electrolyte contacting the electrode, and/or a relatively thin cross-sectional dimension, which may facilitate transport of ions into and out of the electrode. In one set of embodiments, the electrode may have the form of a base and a plurality of protrusions, for instance, as is shown in FIG. 1A in side view. In this figure, an electrode 10 includes a base 15, and a plurality of protrusions 18 that extend away from the surface of the base. As used herein, the base of the electrode is defined as a generally flat, contiguous, featureless surface, and the protrusions are defined a series of extensions that each extend away from the base, although the base and the protrusions, in some embodiments are made from a unitary material, as discussed below.

As shown in FIG. 1, the protrusions are each shown as being generally rectangular; however, in other embodiments, the protrusions may be cylindrical, cone shaped, irregular, rectangular, pyramidal, etc., and may be distributed on the surface of the base in any manner, e.g., regularly or randomly arranged, etc. The protrusions on the base may each be substantially the same shape and/or size, as is shown in FIG. 1A, or the protrusions may have different sizes.

FIG. 1B shows an example of one electrode having a two-dimensional array of protrusions. In this figure, the cross-sections of the protrusions are generally square, although in other embodiments, other shapes are possible, e.g., rectangles or circles. FIGS. 1C and 1D shows a battery that includes such two-dimensional arrays of protrusions, used as a cathode and an anode, in exploded view (FIG. 1C), and when assembled (FIG. 1D), including top and bottom current collectors, in electrical communication with the anode and cathode, respectively. In FIG. 1C, battery 20 includes an anode 12, a cathode 14, and an electrolyte 13. In FIG. 1D, the battery is shown assembled, with a top current collector 17 in electrical communication with anode 12, and a bottom current collector 19 in electrical communication with cathode 14. Additionally, in FIG. 1D, as a non-limiting example, dimensions of a microbattery that could be formed using such electrodes are illustrated.

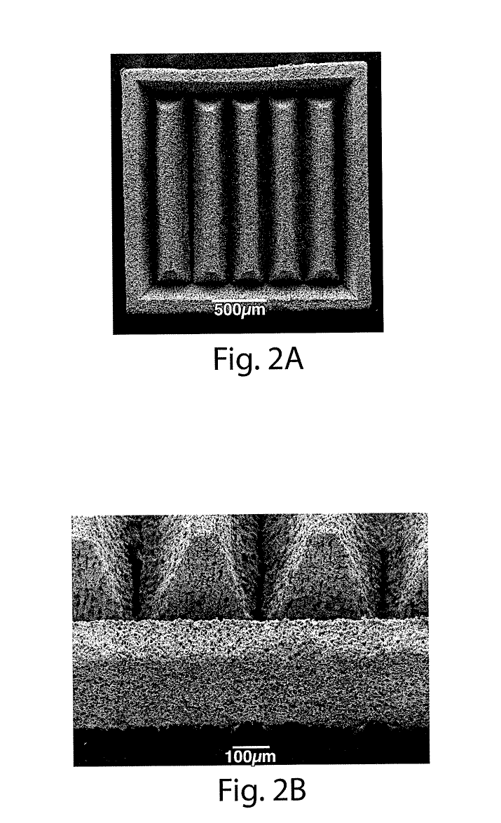

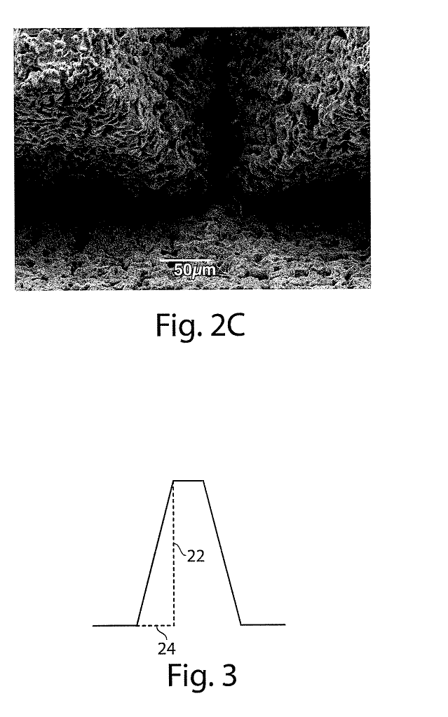

However, in some cases, the protrusions extend along one dimension of the electrode, thereby giving the appearance of “ribs,” that, when viewed in cross-section, has an appearance similar to that shown in FIG. 1A. An example of an electrode having such a series of extended protrusions is shown in FIG. 2A-2C at different magnifications. The electrode in this example was laser-machined from a porous sintered LiCoO₂ material, although other materials and other forming processes can also be used.

In some embodiments, the protrusions may extend a distance of at least about 25 micrometers away from the base of the electrode, i.e., the maximum separation of the end of the protrusion away from the surface of the base of the electrode is about 25 micrometers. In other cases, the protrusions may extend a distance of at least about 50 micrometers, at least about 75 micrometers, at least about 100 micrometers, etc., away from the base of the electrode. As mentioned above, not all of the protrusions may extend the same difference away from the surface of the base. In some cases, the protrusion may have an aspect ratio (i.e., the ratio of the distance the protrusion extends away from the base to the maximum thickness of the protrusion) of at least about 3:1, and in some cases, at least about 5:1, at least about 10:1, at least about 15:1, at least about 20:1, etc.

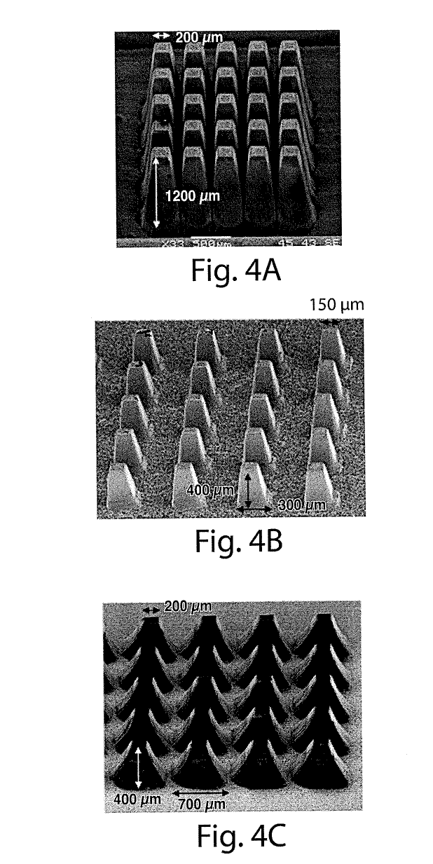

In some cases, the protrusions have sloped sides, i.e., sides that are not orthogonal to the surface of the base. For example, a protrusion may have a pitch of at least about 2:1, and in some embodiments, the pitch may be at least about 3:1, at least about 5:1, or at least about 10:1. The “pitch” of a protrusion, as used herein, is the slope of the protrusion, or the ratio of its “rise” to “run.” The sides of the protrusion need not all have the same pitch. As shown in FIG. 3, a protrusion may have sloped sides, and the pitch is the ratio of the rise of the slope 22 of the protrusion to its run 24. Photomicrographs of such sloped protrusions are shown in FIGS. 4A-4C. FIG. 4A shows sloped protrusions formed from polycrystalline graphite; FIG. 4B shows sloped protrusions formed from polygraphite on alumina, and FIG. 4C shows sloped protrusions formed from HOPG (highly ordered pyrolytic graphite) on alumina. Materials that can be used to form the electrode and/or the protrusions are discussed in detail below.

In some cases, the protrusions may have a shape and/or size such that the protrusion, or at least a substantial fraction of the protrusion, is not more than a certain distance away from the surface of the protrusion. Such a protrusion, for example, may offer a limited distance for Li ions to be transported within the electrode before reaching the surface or the electrolyte, and thus, in some cases, substantially all of the protrusion may participate in Li ion exchange during charging or discharging of the electrode, thereby increasing the efficiency and/or the power density of the electrode. For instance, a protrusion may have a surface and a bulk, where the protrusion has a shape and/or size such that substantially all of the bulk is no more than about 5 micrometers, about 10 micrometers, about 15 micrometers, about 20 micrometers, about 25 micrometers, about 50 micrometers, about 75 micrometers, or about 100 micrometers away from the surface of the protrusion.

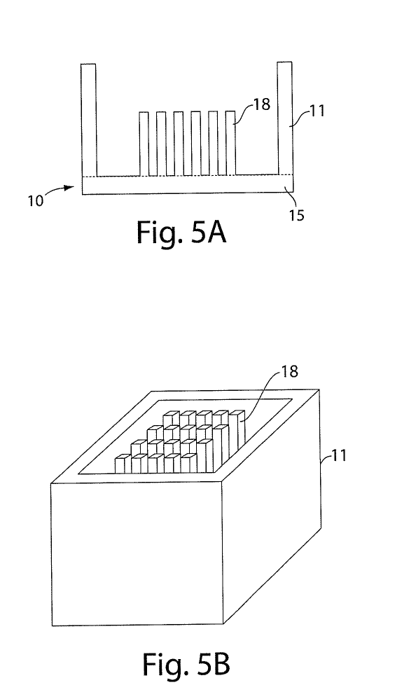

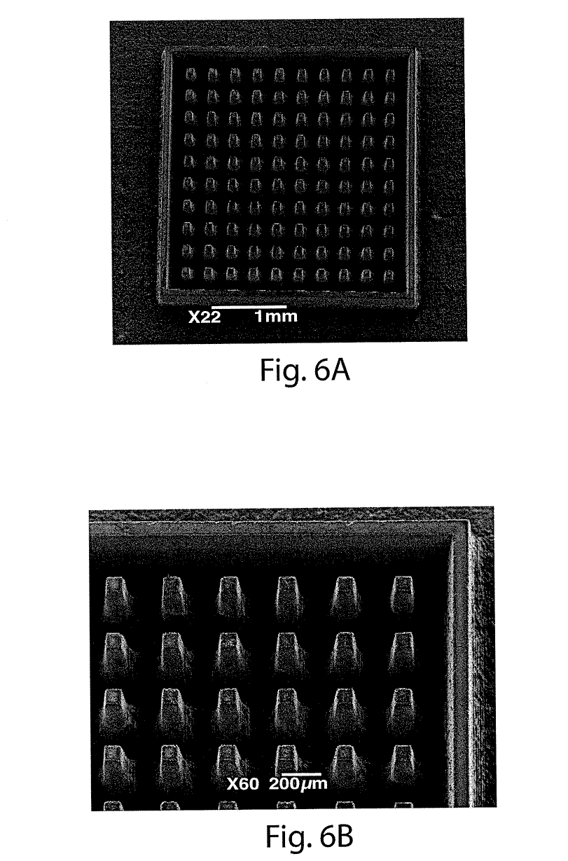

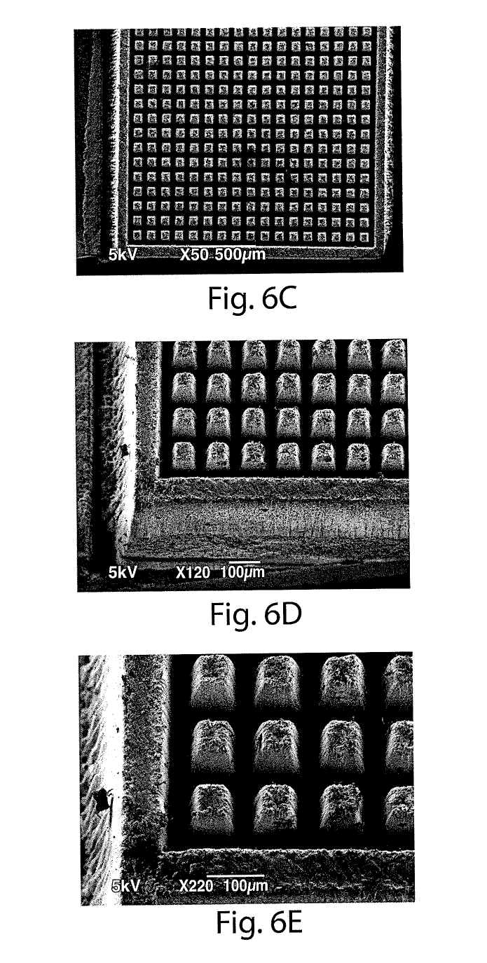

In certain embodiments, the protrusions on the base of the electrode may be at least partially surrounded by a wall or a “can.” For example, as is shown in FIG. 5A in cross section, electrode 10 includes a base 15, a plurality of protrusions 18 that extend away from the surface of the base, and a wall 11 surrounding the protrusions. A three-dimensional view can be seen in FIG. 5B, and photomicrographs of such electrodes are shown in FIGS. 6A-6E. In FIGS. 6A and 6B, the height of the walls and the protrusion is about 0.5 mm, and the width of the protrusions is about 100 micrometers. In FIGS. 6C-6E, the protrusions have a 100 micrometer pitch, and a feature width of 80 micrometers. The walls, as shown in this example, have a square or rectangular arrangement, but in other embodiments, other shapes are possible, for example, circular, hexagonal, triangular, etc.

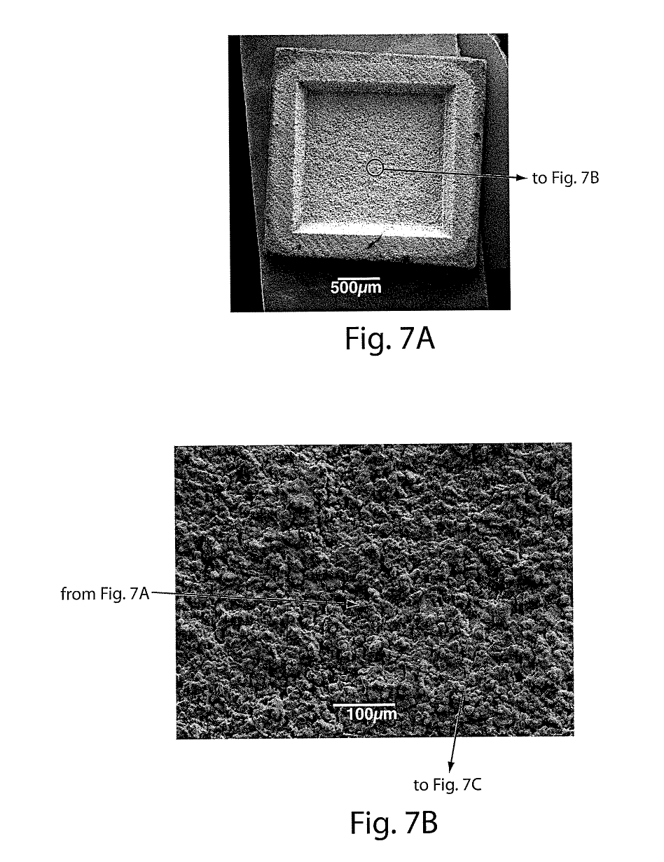

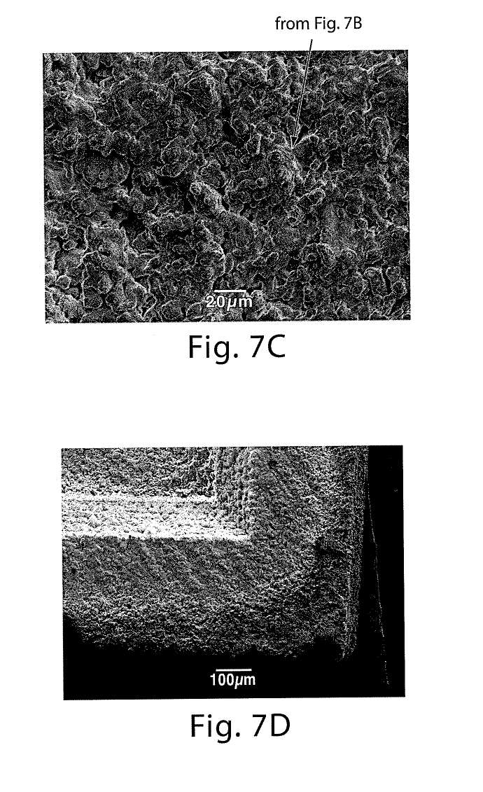

The wall may be same thickness as the protrusions, or of a different thickness. For instance, the wall may have a thickness of less than about 200 micrometers, less than about 175 micrometers, less than about 150 micrometers, less than about 125 micrometers, less than about 100 micrometers, less than about 75 micrometers, less than about 50 micrometers, or less than about 25 micrometers, and the wall thickness may be uniform or non-uniform. The wall may also be orthogonal to the base, or in some cases, the wall may have sloped or tapered sides. A non-limiting example of an electrode having a tapered wall is shown in FIGS. 7A-7D. In addition, as can be seen in FIGS. 7A-7D, an electrode may have a wall on the base without necessarily having any protrusions, in certain embodiments of the invention.

The wall may, in certain embodiments of the invention, be useful to contain an electrolyte and/or other materials within the electrode, i.e., such that it remains in contact with the protrusions of the electrode. The wall may also protect the protrusion from external factors, for example, from forces that might cause the protrusions to deform or break. In some cases, the wall may facilitate the construction of integrated electrode arrays, for example, for microbattery applications. In some cases, as discussed below, the wall is formed, along with the base and optionally the protrusions, from a unitary material. By forming the wall and the base from a unitary material, an airtight or hermetic seal between the wall and the base is naturally formed, which prevents leakage to or from the battery, e.g., leaking of the electrolyte contained within the electrode. In one set of embodiments, the walls and the protrusions are micromachined from a unitary ceramic material, as is discussed in detail below.

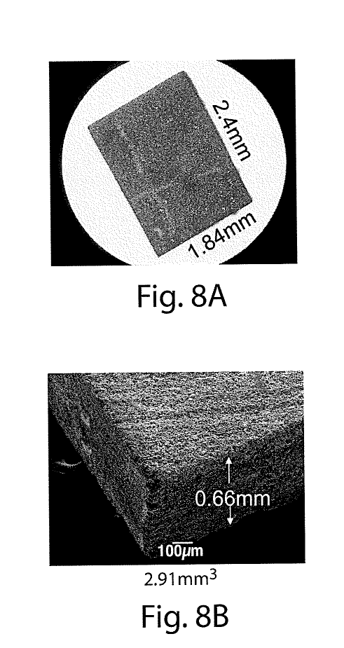

It should be noted here that not all embodiments of the present invention necessarily must include protrusions and/or walls. For example, in some embodiments, the electrode has a substantially planar surface, e.g., as is shown in FIGS. 8A and 8B for an example of an electrode formed in a monolithic shape from sintered LiCoO₂, and having a density of about 85%. Thus, according to another aspect of the invention, relatively high energy densities may be achieved, regardless of the shape of the electrode (i.e., whether or not the electrode is planar or has protrusions, walls, or the like), due to the porosity of the electrode. In some cases, as discussed below, due to the electrolyte-filled porosity of the electrode, substantially all of the electrode may be able to participate in Li ion exchange, e.g., with the electrolyte during charge or discharge.

In some cases, the electrode may have a smallest dimension that is at least about 0.2 mm, and in some cases, at least about 0.4 mm, at least about 0.6 mm, at least about 0.8 mm, at least about 1.0 mm, at least about 1.5 mm, or at least about 2.0 mm.

As used herein, “porous” means containing a plurality of openings; this definition includes both regular and irregular openings, as well as openings that generally extend all the way through a structure as well as those that do not (e.g., interconnected, or “open” pores, as opposed to at least partially non-connected, or “closed” pores). The porous electrode may have any suitable porosity. For example, the porous electrode may have a porosity of up to about 15%, up to about 20%, up to about 25%, up to about 30%, up to about 40%, or up to about 50% (where the percentages indicate void volume within the electrode). Equivalently, the porous electrode may have a density of at least about 50%, and up to about 70%, up to about 75%, up to about 80%, up to about 85%, up to about 90%, or up to about 95%, where the density is the amount of non-void volume present within the electrode material. In some cases, the porous electrode may have an average pore size of less than about 300 micrometers, for example, less than about 100 micrometers, between about 1 micrometer and about 300 micrometers, between about 50 micrometers and about 200 micrometers, or between about 100 micrometers and about 200 micrometers. The average pore size may be determined, for example, from density measurements, from optical and/or electron microscopy images, or from porosimetry, e.g., by the intrusion of a non-wetting liquid (such as mercury) at high pressure into the material, and is usually taken as the number average size of the pores present in the material. Such techniques for determining porosity of a sample are known to those of ordinary skill in the art. For example, porosimetry measurements can be used to determine the average pore size of the porosity that is open to the exterior of the material based on the pressure needed to force a liquid, such as mercury, into the pores of the sample. In some embodiments, some or all of the porosity is open porosity, for example to facilitate filling of the pores by electrolyte. Techniques for forming a porous electrode are discussed in detail below.

Without wishing to be bound by any theory, it is believed that the pores facilitate transport of Li⁺ or other ions from the electrode to the electrolyte. In a material having a porous structure, some of which pores may be filled with an electrolyte (such as described below), Li⁺ or other ions have a shorter distance to travel from the electrode to the electrolyte and vice versa, thereby increasing the ability of the electrode to participate in energy storage, and/or increasing the energy density of the electrode. In addition, as discussed below, in some embodiments, porous electrodes may be fabricated that have a relatively low dimensional strain upon charge and discharge, and such materials can withstand a surprising number of charging or discharging cycles.

In some cases, the volume fraction porosity of the electrode is not constant throughout the electrode, but can vary. For example, the porosity of the surface of the electrode may be lower than the bulk of the electrode, one end of the electrode may have a higher or lower porosity than another end of the electrode, etc. In one embodiment, the surface is nonporous, although the bulk of the electrode is porous. In some cases, porosity differences in an electrode may be created during the process of creating the porous electrode, e.g., during the firing of a powder compact to form a ceramic. However, in other cases, the porosity differences may be intentionally controlled or altered, for example, by laser treatment of the surface, rapid thermal annealing of the ceramic, physical vapor or chemical vapor deposition, by adding particles or other materials to the electrode surface, by coating the electrode with a material, such as a sol-gel material, or the like. The porosity at the surface and variation in porosity with distance from the surface are readily observed and quantified using techniques such as electron microscopy and image analysis of the plan and cross-sectional views of the sample.

Electrodes such as those described above (e.g., porous, having protrusions and/or walls, etc.) may be formed, according to another aspect of the present invention, from a ceramic or ceramic composite. A ceramic is typically an inorganic non-metal material, although the ceramic can include metal ions within its structure, e.g., transition metals or alkali ions such as Li⁺ or Na⁺ or K⁺, as discussed below. A ceramic composite is typically a mixture including one or more ceramic materials, e.g. a mixture of different ceramic phases, or a mixture of a ceramic and a metal or a ceramic and a polymer, and may have improved properties compared to the ceramic alone. For example, a ceramic-ceramic composite may have an ion storage ceramic combined with a fast-ion conducting ceramic to impart higher ionic conductivity to the composite while still retaining ion storage functions. A ceramic-metal composite may have improved electronic conductivity and improved mechanical strength or fracture toughness compare to a pure ceramic. A ceramic-polymer composite may have improved ionic conductivity if the polymer is an electrolyte having higher ionic conductivity than the ceramic, as well as having improved fracture toughness or strength. Combinations of these and/or other composites are also contemplated. In some embodiments, the electrode consists essentially of a ceramic, and in some cases, the electrode is formed from a unitary ceramic material. In some embodiments, the electrode material having the lower electronic conductivity is formed from a unitary ceramic or ceramic composite, which may improve electron transport to and from the electrode during use of the battery. Non-limiting examples of suitable ceramic materials include those which are able to transport Li ions during charging/discharging. The ceramic may be one in which Li ions can be removed during charging (a “Li-extraction” ceramic), i.e., the ceramic is one that contains Li ions that can be removed to form a limiting composition material (e.g., Li ions can be extracted from LiCoO₂ to produce Li_{0.5}CoO₂, from LiNiO₂ to produce Li_{0.3}NiO₂, etc.). Examples of potentially suitable ceramic materials comprising Li include, but are not limited to, LiCoO₂, LiNiO₂, LiMn₂O₄, or Li₂Mn₂O₄ spinel, LiMnO₂ of the orthorhombic or monoclinic polymorphs, LiMPO₄, olivines where M may be one or more of Ni, Co, Mn, and Fe, Li₄Ti₅O₁₂, derivatives or modified compositions of these compounds, and/or physical mixtures of one or more of these compounds, or the like. In some cases, as discussed below, the ceramic has a relatively small volumetric or linear strain differential during the insertion and removal of an ion. Examples of such ceramics include LiCoO₂, LiNiO₂, LiFePO₄, and Li₄Ti₅O₁₂, and their derivative compositions and structures as well as mixtures of such oxides.

Generally, the electrode may be formed out of a single, unitary “block” of ceramic, e.g., by “carving” the ceramic in some fashion, for instance, through micromachining or etching techniques or the like, to produce the final shape of the electrode. The electrode may also be formed in a desired shape from a powder or powder suspension, in some embodiments, using any suitable technique, for instance, techniques such as tape-casting, interrupted tape-casting, slip-casting, pressing, and embossing, and the powder or powder suspension may be fired to obtain a sintered material after its formation.

During processes such as those described above, portions of the unitary starting material are removed in some fashion, to produce the final shape of the electrode. Thus, the unitary starting material is of a size larger than the final electrode that is “carved” from the starting material. As discussed below, such unitary ceramic materials may have several advantages, including smaller strain differentials, lack of stress-concentrating features, or the lack of joints or seams by which ions, fluids, or gases could pass through. As used herein, the term “unitary” is not meant to include structures, such as conjoined individual particles, that are formed as separate, individual units which are then agglomerated together in some fashion to form the final structure; instead, a unitary material is one that is processed (e.g., by sintering) such that any individual particles used to form the material cease to be readily separable as individual particles.

For example, a unitary material may be formed from a ceramic precursor, e.g., a powder, through a sintering process. For example, the ceramic precursor may be pressed and/or heated such that the powder particles are bonded together, forming a unitary whole. Porosity may be created within the sintered ceramic material, for example, by controlling the initial powder particle size distribution, powder packing density, the firing temperature and time, rate of heating during various stages of the firing process, and/or the firing atmosphere. Methods to control the shrinkage (densification) and evolution of porosity in powder-based materials to create a desired density or porosity are known to those of ordinary skill in the art.

In some instances the electrode comprising a unitary material may be formed in its desired shape from a powder mixture or powder suspension using such processes as tape casting, interrupted tape casting, slip casting, pressing, rolling, extruding, embossing, or other such processes.

The compound or compounds of the electrode may have, in some cases, a molar volume difference between the charged and discharged state of the cell of less than about 30%, less than about 15%, less than about 10%, or less than about 5%. In some embodiments the compound or compounds of the electrode has a linear or a volumetric strain between the charged and discharged state of the cell of less than about 20%, less than about 15%, less than about 10%, less than about 5%, less than about 3%, less than about 2%, or less than about 1%. In some embodiments, the compounds of the electrode include at least one compound that increases in molar volume at least some compositions during use and at least one compound that decreases in molar volume at least some compositions during use. In some embodiments, the net volume change of the electrode between the charged and discharged state of the battery is decreased by combining at least one compound that has a net positive volume change between the charged and discharged state, with at least one compound that has a net negative volume change between the charged and discharged state of the battery. In one set of embodiments, the electrode is fabricated from a ceramic material having a relatively small linear or a volumetric strain differential when the electrode is infiltrated with Li ions.

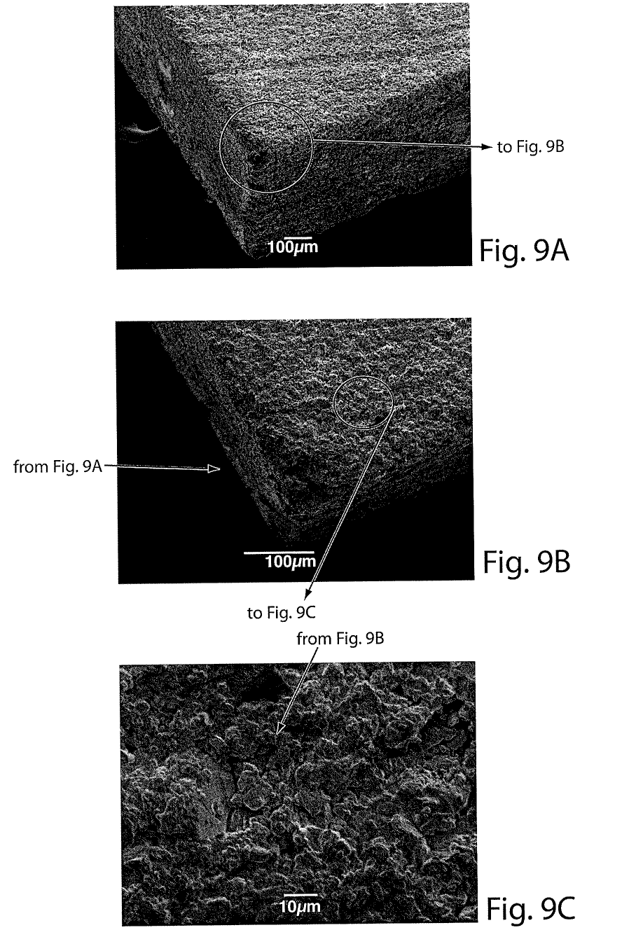

Non-limiting examples of such materials include LiCoO₂ (having a linear strain differential averaged along all crystallographic orientations of about +0.6% upon delithiating to a composition of about Li_{0.5}CoO₂) and LiNiO₂ (having a linear strain differential of about −0.9% upon delithiating to a composition of about Li_{0.3}NiO₂). Such a material may be able to withstand a relatively large number of charging or discharging cycles while remaining free of cracks or otherwise degrading, as the material does not expand or contract significantly during charging or discharging. Linear strain is generally defined as the change in length of a material with respect to the initial length (ΔL/L₀), and volumetric strain is similarly defined, but with respect to the initial volume. For example, a material of the instant invention may be able to withstand at least 6 cycles, at least 10 cycles, at least 15 cycles, or at least 20 cycles of complete charging and discharging (e.g., at a C/20 rate), while remaining free of identifiable cracks or other degradations (e.g., chips, peeling, etc.) that can be observed under scanning electron microscopy. As an example, in FIGS. 9A-9C, a ceramic material used as an electrode was fully charged and discharged (i.e., “cycled”) at a C/20 rate 6 times, and then studied using scanning electron microscopy (SEM). Thus, in another set of embodiments, the electrode is able to retain at least 50% of its initial storage capacity after at least 6 charge-discharge cycles at a C/20 rate. As can be seen in these figures (at different magnifications, as shown by the scale bars), no obvious degradation or cracking of the ceramic material was observed. In contrast, many prior art materials are unable to withstand such conditions.

It is unexpected that a sintered ceramic electrode as described herein could be electrochemically cycled repeatedly without substantial evidence of mechanical failure. Firstly, intercalation compounds such as the lithium transition metal oxides typically have a rock salt or ordered rock salt structure, spinel structure, olivine structure, or rutile structure, amongst others. These typically have high elastic moduli and low fracture toughness and are brittle. For such compounds, the linear strain to failure is typically less than about 1%, an amount that is exceeded by the typical linear strain induced upon charging and discharging. Also, several studies have shown that particles of intercalation compounds used in rechargeable lithium batteries sustain fracture and disorder and defect formation in their crystalline structure upon being charged and discharged. In addition, the strains induced upon charging and discharging may, in some cases, be larger than the thermal strains typically induced in ceramic parts during thermal shock that leads to fracture, such as the thermal shock of a glass body. Thus, it is unexpected that the electrodes could sustain the differential strains during charging and discharging, which necessarily induce strain and stress gradients since different portions of an electrode undergo different degrees of expansion or contraction as ions are added from the opposing electrode. As an example, Table 1 shows the linear strain to failure of several example compounds induced upon charging and discharging. Table 1 also shows a listing of several well-known lithium storage compounds and their volumetric and average linear strains during charging and discharging.

TABLE 1

| | | | | |
|---|---|---|---|---|
| Lithium | | | | |
| Storage | Limiting | Volume Strain | Linear Strain* | Potential |
| Compound | Composition | ΔV/V₀ | ΔL/L₀ | vs. Li/Li⁺ |

Li-extraction

| | | | | |
|---|---|---|---|---|
| LiCoO₂ | Li_{0.5}CoO₂ | +1.9% | +0.6% | 4.0 V |
| LiFePO₄ | FePO₄ | −6.5% | −2.2% | 3.4 V |
| LiMn₂O₄ | Mn₂O₄ | −7.3% | −2.5% | 4.0 V |
| LiNiO₂ | Li_{0.3}NiO₂ | −2.8% | −0.9% | 3.8 V |

Li-insertion

| | | | | |
|---|---|---|---|---|
| C(graphite) | 1/6 LiC₆ | +13.1% | +4.2% | 0.1 V |
| Li₄Ti₅O₁₂ | Li₇Ti₅O₁₂ | 0.0% | 0.0% | 1.5 V |
| Si | Li_{4.4}Si | +311% | +60% | 0.3 V |
| β-Sn | Li_{4.4}Sn | +260% | +53% | 0.4 V |

*for a randomly oriented polycrystal

As shown in the examples below, dense sintered electrodes of intercalation oxides with substantial strain during charge and discharge can be electrochemically cycled without experiencing detrimental mechanical failure, in contrast to the prior art. Detrimental mechanical failure would include fracture or multiple fractures that propagate across the electrode, crumbling or comminuting of the sintered particles causing a loss of connectivity between the particles, or a significant loss of electrochemical storage capability due to such events. This is observed in compounds such as LiCoO₂, in which the differential strain during charge and discharge is near the strain to failure of a brittle ceramic, as well as in compounds such as nanoscale doped olivines in which the differential strain is above that which would be expected to cause failure.

Without being bound by any particular scientific interpretation, it is believed that during electrochemical cycling of various electrodes of the invention, microcracking of particles and at grain boundaries between particles may occur, but that such damage remains localized and does not propagate across the electrode causing failure as it would in a typical sintered ceramic of similar physical properties and sintered density subjected to the same strain. Instead, the strains induced during electrochemical cycling may be anisotropic at the crystal level, and/or may be able to accommodate microcracks distributed widely throughout the material, which may dissipate stored elastic energy without causing failure on a length scale much larger than the particle size. Such ceramics do not exhibit high strength in comparison to other ceramics of comparable density and particle and pore size, but can be damage tolerant in some cases. Considered in such manner, various electrodes of the invention can be made damage-tolerant by taking into account the differential strain during charging and discharging, the crystalline anisotropy in strain, the crystallite size, agglomerate size, sintered density, and other microstructural and processing considerations well-known to those skilled in the art of ceramic materials processing. For example, the larger crystalline strain of LiFePO₄ compared to LiCoO₂ necessitates a smaller particle size to avoid damaging fracture events, all other factors such as density, particle size distribution and pore size distribution being constant.

Thus in some embodiments, a porous electrode of the present invention that does not comprise additional ductile phases providing mechanical toughness may have a differential volume change of less than about 20%, less than about 15%, or less than about 10% between the charged and discharged state. In some embodiments, the microstructure of the sintered electrode, as characterized by well-known measures such as grain size, grain shape, grain size distribution, pore volume, the relative fractions of open and closed porosity, pore size distribution, or pore topology, is adjusted to permit reversible cycling with relatively low capacity loss. In some embodiments, the particle size may be reduced to improve damage tolerance, for example using particles having a primary (single crystallite) size of less than about 500 nm, less than 200 nm, or less than about 100 nm. In some embodiments the particles have an anisometric shape, including being in the shape of a rod or plate in which the aspect ratio (ratio of the longest dimension to the shortest) is at least a factor of 2, at least a factor of 5, or at least a factor of 10, which may improve damage tolerance in some cases.

In yet another set of embodiments, the electrodes may comprise a mixture of compounds, such compounds being selected to achieve a desired volumetric or linear differential strain upon charging and discharging the battery. By selecting compounds in this manner, the electrode may attain improved tolerance to electrochemical cycling induced mechanical damage, and/or the total volume change of the cell constituents, including both anode and cathode, during cycling may be reduced. As a non-limiting example, referring to Table 1, LiCoO₂ can be seen to experience a net volume contraction of about 1.9% upon being charged to the composition Li_{0.5}CoO₂, whereas LiFePO₄, LiMn₂O₄, and LiNiO₂ all exhibit volumetric expansion upon being charged. For a mixture of LiCoO₂ with one or more of the latter three compounds, under particular charging conditions such as voltage and current rate and time, each of the constituent materials reaches a particular lithium concentration, and therefore a particular change in volume compared to the starting discharged state. Accordingly, in one embodiment, the electrode is selected to comprise a mixture of compounds, such compounds being selected to achieve a volumetric or linear differential strain of less than about 20%, less than about 15%, less than about 10%, less than about 5%, less than about 3%, less than about 2%, or less than about 1%, upon charging and discharging the battery

These volumetric changes are readily determined by methods, such as X-ray diffraction of the charged electrode, that are well-known to those of ordinary skill in the art. For instance, the net volume change of the electrode at any particular state-of-charge may be selected by mixing the constituents in certain ratios easily determined by calculation or experimentation. As an example, a mixture of LiCoO₂ and LiNiO₂ may be selected to provide net zero expansion between the charged and discharged states.

In some embodiments, the porous sintered electrode is selected to comprise the less electronically conductive of the cathode and anode materials. The porous sintered electrode construction may provide a continuous interconnected material and/or improve the electronic conductivity of the ion storage material network compared to, for example, a compacted powder that has not been sintered. Thus the electronic conductivity of the sintered porous electrode can be as good as, or better than, that of a conventional lithium ion battery electrode that typically comprises an active material powder, conductive additive such as carbon black, and polymer binder, while having lesser or no additive phases, and having a higher volume fraction of additive material. As shown in the examples, a sintered LiCoO₂ or sintered lithium metal phosphate olivine cathode can have much higher volume packing density, e.g., as high as 70-85% density, and can be electrochemically cycled without incorporating any conductive additive or binder in the electrode.

In some embodiments, the sintered electrode comprises a lithium storage compound that increases in electronic or ionic conductivity when alkali ions are removed or inserted into said compound. As a non-limiting example, Li₁₋ₓCoO₂ may exhibit increased electronic conductivity with increasing x, and may undergo a semiconductor to metal transition at x˜0.03. Thus, a benefit may be provided under certain conditions by utilizing LiCoO₂ or other compounds exhibiting such behavior in a battery, in one embodiment of the invention. As the battery is charged and lithium is extracted from the LiCoO₂, the impedance of the electrode decreases, which may facilitate electrochemical use of the electrode. A further benefit may be realized in some cases based on the typical behavior of lithium rechargeable cells where there is a first cycle irreversible loss of lithium due to the formation of side-reaction products. The irreversible consumption of lithium may cause the LiCoO₂ to remain lithium-deficient thereafter, in certain cases, even in the discharged state of the cell, and thereby may cause the sintered cathode to retain a high electronic conductivity in some embodiments of the invention.

In some embodiments, a porous electrode of the present invention may contain an electrolyte within the pores of the porous electrode. The electrolyte, in some cases, may be a liquid electrolyte, such as a mixture of alkyl carbonates and a lithium salt such as LiPF₆, or a polymer electrolyte, such as polyethylene oxide or a block copolymer. The electrolyte may also be, for instance, a gel or an inorganic compound. Non-limiting examples of inorganic electrolytes include a lithium phosphorus oxynitride compound, lithium iodide, or the like. In some cases, the electrolyte can comprises any combination of these and/or other materials.

In some cases, the electrolyte and/or the electrode may contain a lithium salt to impart lithium ion conductivity. Formulations for such electrolytes, including additives to improve safety, cycle life, and/or calendar life amongst other attributes, are known to those skilled in the art, and it should be understood that any such formulation may be used, based on the desired attributes of the battery for a particular application. The electrolyte contained within the electrode may or may not have the same concentration or composition as the electrolyte that separates the electrode from an opposite electrode (i.e., separating the cathode and the anode within a battery). A liquid electrolyte may be useful, for example, to facilitate flow of Li ions into and out of the porous electrode. In some cases, the liquid electrolyte may comprise Li ions. An example of such an electrolyte is one using LiPF₆ as the lithium salt. Depending on the porosity of the electrode, the liquid electrolyte may be introduced into the pores of the electrode by exposing the pores to the liquid electrolyte, for instance, as discussed below. The electrolyte, in some cases, may also surround the protrusions of the electrode (if protrusions are present). For example, the electrolyte may be contained within the electrode (e.g., within walls of an electrode, if a wall is present), bathing the protrusions in electrolyte.

Another aspect of the present invention is directed to a separator. The anode and the cathode in a battery or other electrochemical device are generally electronically insulated from each other while having an electrolyte to permit ion exchange. A porous “separator” material that is infused with an ion-conducting electrolyte can serve this function. According to one set of embodiments, a separator is used in a battery that comprises a porous polymer film, and/or a porous ceramic layer. In some cases, the film or layer may have a pore fraction of between 10% and 70% by volume, or between 25% and 75% by volume, and a thickness between about 5 micrometers and about 500 micrometers, between about 100 micrometers and about 2000 micrometers, between about 300 micrometers and about 1000 micrometers, etc. The film or layer may also have a porosity of at least about 30%, at least about 40%, or at least about 50%, and/or the porosity may be no more than to about 60%, about 65%, about 70%, or about 75%. The thickness may also be less than about 300 micrometers, or less than about 100 micrometers, and/or greater than 10 micrometers, greater than 30 micrometers, or greater than about 50 micrometers. In some embodiments, a relatively thick porous ceramic separator may be useful in decreasing the frequency of occurrence of internal short circuits due to lithium dendrite formation.

According to another set of embodiments, the electrolyte is nonporous (i.e., solid), i.e., the electrolyte does not contain “pinholes” or defects (such as pores or cracks) through which Li dendrite formation leading to short circuits can occur, even after tens, hundreds, or thousands of cycles of charging or discharging. In some cases, the electrolyte comprises Li ions, which may be useful, to facilitate flow of Li ions into and out of the adjacent electrodes. Amongst numerous possible choices, one example of such an electrolyte is LiPON (lithium phosphorus oxynitride), an inorganic material typically made in thin-film form by sputtering. Another example of an electrolyte is lithium iodide (LiI). In one set of embodiments, the electrolyte is present as a film, which can be deposited by sputtering or other physical vapor or chemical vapor methods. In some cases, the electrolyte is a conformal film formed upon the electrode surface using layer-by-layer deposition, i.e., where discrete molecular layers of electrolyte material are added to the electrode until a suitably thick layer of electrolyte has been built up. Those of ordinary skill in the art will be aware of suitable layer-by-layer deposition techniques, which typically involve the application of molecular layers of alternating positive and negative charge from wet chemical solution.

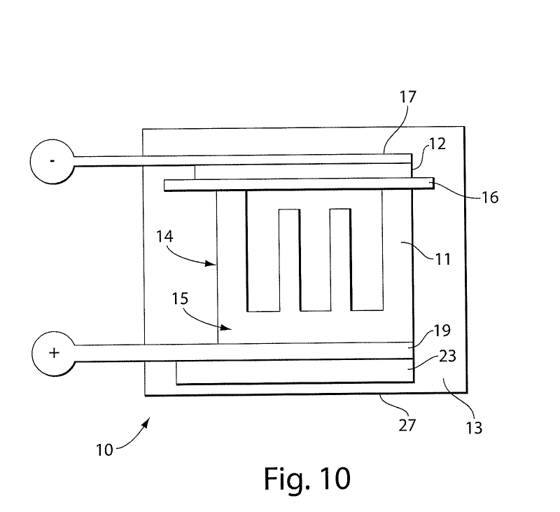

The nonporous electrolyte may be used, in some embodiments, to seal the electrode surface, and in some cases, to create a hermetically sealed compartment containing the electrode and an electrolyte, such as a liquid or a polymer electrolyte, within the sealed compartment. Thus, the hermetically sealed compartment may be defined by the walls of the cell, the base of the electrode, and the lid formed by the nonporous electrode. A non-limiting example of a battery having such a nonporous electrolyte is shown in FIG. 10, in which the nonporous electrolyte layer 16 seals the compartment beneath it formed by the walls of the electrode 15, within which an electrolyte resides. The volume of the cell outside of this compartment may or may not be also filled with electrolyte. The nonporous electrolyte may have any suitable size and/or shape. For example, portions of the electrolyte may extend into the interior space of the electrode, or the electrolyte may essentially define a substantially planar layer or “lid” above the walls of the electrode, e.g., as in FIG. 10. For instance, the nonporous electrolyte may have a thickness of at least about 1 micrometer, at least about 3 micrometers, at least about 5 micrometers, at least about 10 micrometers, at least about 20 micrometers, at least about 30 micrometers, at least about 50 micrometers, etc.

Yet another aspect of the invention is directed to techniques for making such electrodes and batteries or microbatteries. In one set of embodiments, a unitary ceramic material is used, and in some, but not all embodiments, the material may be etched in some fashion, for example, using micromachining techniques such as laser micromachining, or dry etching or wet chemical etching methods well known to those skilled in the art of fabricating microelectromechanical systems (MEMS). Such machining processes may be used to form the walls and/or protrusions on the surface of the base of the electrode. In another set of embodiments, the protrusions or walls of the electrode are produced directly by forming a starting powder or composite mixture under pressure using a die having the inverse of the desired final geometry. The electrode thus formed may be used directly or may be sintered after forming.

In the non-limiting example of a completed battery shown in FIG. 10, the cathode 14 has a plurality of protrusions 18 that extend away from the surface of a base 15 of the cathode, surrounded by a wall 11. In addition, the battery may be contained within a packaging material 27, as is shown in FIG. 10. Packaging materials for batteries are known to those skilled in the art. For lithium batteries, non-limiting examples include polymers, polymer-metal laminates, thin-walled metal containers, metal containers sealed with polymers, and laser-welded metal containers. For the batteries of the invention, one embodiment uses inorganic compounds such as insulating oxides as the packaging material. Such compounds may be applied to the exterior of the battery by physical vapor deposition or coating from wet chemical solutions or particle suspensions, or the package may be pre-formed and the battery inserted within.

The cathode may be laser-micromachined, and has a height of about 500 micrometers in the particular example in FIG. 10. The cathode is in electrical communication with a current collector 19, such as a gold current collector, which in turn is positioned on a substrate 23, for instance, an alumina substrate. The collector may have any suitable thickness, for example, about 25 micrometers, about 50 micrometers, about 75 micrometers, about 100 micrometers, etc. In some cases, the electrode may have a thickness of between about 100 micrometers and about 2000 micrometers, or between about between 300 micrometers and about 1000 micrometers. Similarly, the substrate may have any suitable shape and/or dimensions, depending on the cathode. For instance, the base may have a thickness of at least about 0.5 mm, at least about 0.75 mm, at least about 1 mm, at least about 2 mm, etc.

In some embodiments, within the walls of cathode 15, which may be porous, is a liquid electrolyte 13, for example about 1.0 M to about 1.5 M, e.g., about 1.33 M, of LiPF₆ dissolved in a mixture of organic and/or alkyl carbonates. Such liquid electrolytes are well-known to those skilled in the art of nonaqueous batteries, and may, in some cases, contain additive compounds that stabilize the solid-electrolyte interface (SEI) between the electrode and the electrolyte, improve the temperature range over which the battery may be used, provide flame retardance, suppress gas formation, and/or retard the growth of lithium dendrites. The liquid electrolyte is contained within the electrode via a nonporous electrolyte 16, for example, a solid inorganic or a polymeric electrolyte. The nonporous electrolyte may also conformally cover the surfaces of cathode 15. The nonporous electrolyte may be able to conduct electrons and/or ions back and forth between the cathode and the anode, and may have any suitable thickness or shape, for example, a thickness of at least about 1 micrometer, at least about 3 micrometers, at least about 5 micrometers, at least about 10 micrometers, at least about 20 micrometers, at least about 30 micrometers, at least about 50 micrometers, etc.

In the example of FIG. 10, the anode 12, positioned adjacent to the nonporous electrode, is in electrical communication with an anode current collector 17, such as a metal current collector (e.g., Cu). The anode current collector may have any suitable thickness, for example, at least about 1 micrometer, at least about 3 micrometers, at least about 5 micrometers, at least about 10 micrometers, at least about 25 micrometers, at least about 50 micrometers, at least about 75 micrometers, at least about 100 micrometers, etc., and may or may not be the same thickness and/or comprise the same materials as the cathode current collector, depending on the embodiment and the application. In instances where nonporous electrolyte 16 conformally coats the surface of electrode 15, anode 12 may also conformally coat the film of electrolyte 16 in some cases, or may fill the space between the protrusions of electrode 15 while remaining everywhere separated from the electrode 15 by the conformal electrolyte film in certain embodiments. In some embodiments the electrode 15 is the initial source of the alkali ions that are stored in the electrodes during charge and discharge, and no anode is used, but simply a negative current collector.

In some cases, alkali ions, such as lithium, are deposited at the negative current collector as alkali metal upon charging of the battery, and/or are removed and deposited in the positive electrode upon discharge. In some embodiments, disposed on the negative current collector is a material to facilitate the further deposition of alkali metal during charging of the battery. This material may be an alkali metal, such as lithium metal, or may be an anode-active compound for lithium ion batteries that intercalates or alloys with lithium metal without enabling the precipitation of metallic lithium. Such compounds include carbon materials such as graphite or hard carbons, intercalation oxides such as Li₄Ti₅O₁₂, metals and metalloids such as B, Al, Ag, Au, Bi, Ge, Sn, Si, Zn, alloys comprising one or more of such metals and metalloids, and mixtures of such metals or metalloids or their alloys. In some embodiments, the amount of such anode-active material is at least sufficient to completely absorb the lithium supplied by the cathode-active material during charge, as is the case in conventional lithium-ion batteries. In other embodiments, however, the amount of such material is lower, and the material may both saturate with the alkaline metal and provide a location for the further deposition of the alkali metal as the battery is charged.

As mentioned above, the ceramic electrode may be formed, for example, by sintering particles together, e.g., forming a unitary material. However, the invention is not limited to sintered ceramics; for instance, other ceramic materials or composites may be used. Techniques for sintering particles to form a ceramic are known to those of ordinary skill in the art, e.g., forming a sintered ceramic by pressing and/or heating a precursor to form the ceramic. In one set of embodiments, such sintering may be used to form a porous unitary structure. As discussed, porosity may be created within the sintered ceramic material, for example, by controlling the sintering temperature and pressure, and such process conditions can be optimized to create a desired density or porosity using routine optimization techniques known to those of ordinary skill in the art.

In some embodiments, porosity is introduced into the sintered electrode by incorporating with the starting powder a constituent that can be later removed, which may thus leave behind pores under some conditions. Such constituent may be referred to as “fugitive material.” For example, a fugitive material that is incorporated into the compacted powder that becomes the sintered electrode may be removed by any suitable technique, for example, chemical dissolution, melting and draining of the melted liquid, sublimation, oxidation, and/or pyrolysis, while leaving the material of the sintered electrode behind. Examples of such fugitive materials include, but are not limited to, ice, which may be moved by melting or sublimation, naphthalene, which may be sublimed, polymer constituents such as latex spheres or polymer fibers, which may be chemically dissolved, melted, and/or pyrolysed, and carbonaceous particles or platelets or fibers, which may be removed by oxidation at elevated temperatures. Such carbonaceous particles may be, for instance, carbon or graphitic spherical particles, graphite platelets, graphite or carbon fibers, vapor-grown carbon fibers (VGCF), and carbon nanofibers or carbon nanotubes. As a specific example, LiCoO₂ is typically fired in oxidizing gaseous atmosphere such as air or oxygen. By including carbon fibers in a compact made from LiCoO₂ powder, and pyrolyzing the carbon fibers upon firing in oxidizing atmosphere, elongated pore channels may be left behind in the sintered LiCoO₂ compact which, when filled with electrolyte, may be useful for ion transport and thus to the battery's power and energy utilization.

The desired shape of the electrode may be fashioned using micromachining techniques such as laser micromachining, deep reactive-ion etching, ion-milling, or the like. Those of ordinary skill in the art will be familiar with such techniques. For instance, in laser micromachining, a laser is directed at the unitary ceramic material. The laser light, when interacting with the ceramic material, may melt, ablate, or vaporize the material, which may be used to control the shape of the final electrode. Thus, laser micromachining can produce an object having a desired shape by removing, in some fashion using a laser, everything that does not belong to the final shape. The laser may have any suitable frequency (wavelength) and/or power able to destroy or otherwise remove such ceramic materials in order to produce the final structure for use in a battery or other electrochemical device.

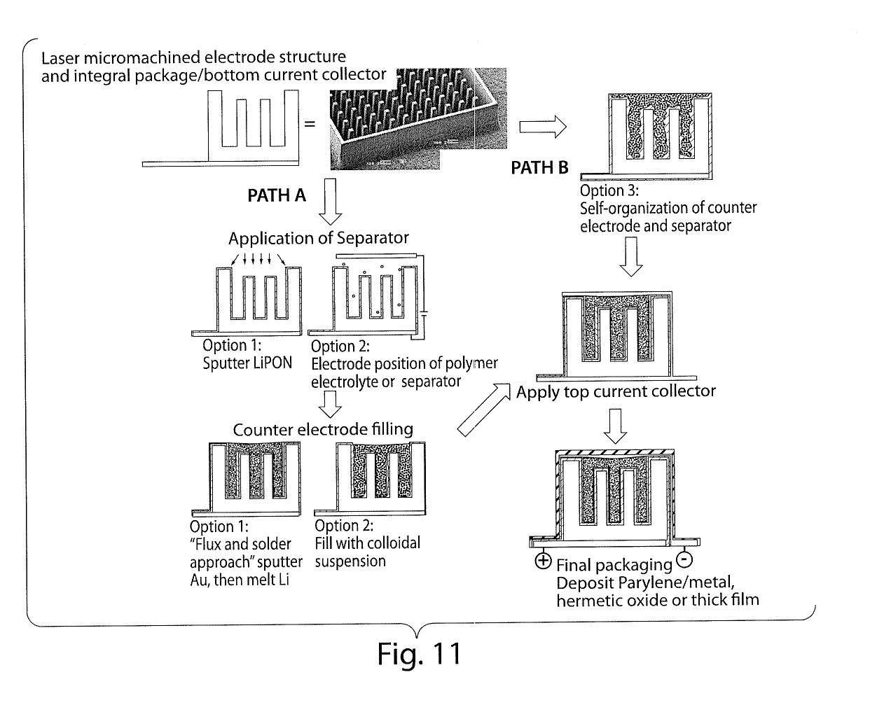

The following is a non-limiting example of a method of manufacturing an embodiment of the invention. Referring now to FIG. 11, in pathway A, the creation of a battery, which may be a microbattery, having a plurality of protrusions and a wall surrounding the plurality of protrusions, is shown. A unitary ceramic material is formed into an electrode having a plurality of protrusions and a wall surrounding the plurality of protrusions using techniques such as laser micromachining. The electrode may also contain a current collector, for instance comprising gold or another metal, such as silver.

In one technique, a separator or electrolyte layer comprising LiPON and/or a polymer or organic electrolyte is first added to the electrode. As shown in FIG. 10, LiPON may be sputtered onto the electrode, or a polymer or organic separator may be deposited onto the electrode in some fashion, for instance, using coating from sol-gel solution, electrodeposition techniques, or layer-by-layer assembly.

Next, the counterelectrode is added to substantially fill the remaining space. In one technique, the interior space defined by the walls of the electrode is filled with a colloidal suspension, the colloidal particles being the negative electrode material and optionally additive particles such as conductive additives or binders. However, in another technique, a “flux and solder” approach is used, which Au is first sputtered onto the separator, then Li (e.g., Li solder) is melted onto the Au. Such a technique may be useful in cases where the electrode and/or the electrolyte contains a material that Li metal, when in a liquid state, will not “wet” or substantially adhere to. In such cases, gold or another compatible metal that Li will “wet” when Li is in a liquid state, is used to facilitate bonding. Without wishing to be bound by any theory, it is believed that Li is able to react with the metal to wet the surface. The top current collector (e.g., a metal, such as Cu, is then added, and optionally, the battery is sealed. The battery can then be packaged, e.g., by depositing parylene and/or a metal hermetic oxide or thick film onto the battery.

In another set of embodiments, a battery, such as a microbattery, having a plurality of protrusions and a wall surrounding the plurality of protrusions can be created as follows. Referring again to FIG. 11, in pathway B, the creation of a battery may proceed by allowing self-organization of the counter electrode and the separator to occur. In this approach, repulsive forces between the electrode and the counterelectrode are used to create a separation that is spontaneously filled by separator or electrolyte material. The repulsive forces used to self-organize the two electrodes with respect to each other include but are not limited to van der Waals forces, steric forces, acid-base interactions, and electrostatic forces. Subsequently, as before, a top current collector (e.g., a metal, such as Cu, is then added, and optionally, the battery is sealed). The battery can then be packaged, e.g., by depositing parylene and/or a metal hermetic oxide or thick film onto the battery.

U.S. patent application Ser. No. 10/021,740, filed Oct. 22, 2001, entitled “Reticulated and Controlled Porosity Battery Structures,” by Chiang, et al., published as U.S. Patent Application Publication No. 2003/0082446 on May 1, 2003, and U.S. patent application Ser. No. 10/206,662, filed Jul. 26, 2002, entitled “Battery Structures, Self-Organizing Structures, and Related Methods,” by Chiang, et al., published as U.S. Patent Application Publication No. 2003/0099884 on May 29, 2003, are incorporated herein by reference. Also incorporated herein by reference are U.S. Provisional Patent Application Ser. No. 60/931,819, filed May 25, 2007, by Chiang, et al.; U.S. Provisional Patent Application Ser. No. 61/027,842, filed Feb. 12, 2008, by Marinis, et al.; and U.S. patent application Ser. No. 10/329,046, filed Dec. 23, 2002, entitled “Conductive Lithium Storage Electrode,” by Chiang, et al., published as U.S. Patent Application Publication No. 2004/00055265 on Jan. 8, 2004.

The following examples are intended to illustrate certain embodiments of the present invention, but do not exemplify the full scope of the invention.

### EXAMPLE 1

This example illustrates an integrally packaged, solid-state lithium rechargeable microbattery with a 3-dimensional interpenetrating-electrode internal architecture, in accordance with one embodiment of the invention. Such microbatteries may have the capability for outer package aspect ratios of (for example) less than 5:1 for maximum to minimum dimensions (i.e., not restricted to thin planar configurations), active materials packaging fraction of >75% in a 1 mm³ volume, under which conditions they will exceed an initial energy density target of 200 W h/l by a factor of 3 to 7. The approach in this example will use currently available and proven cathode and anode materials, but does not exclude higher energy or higher rate active materials in the future.

The microbatteries in this example will allow energy densities of about 200 W h/l to about 1500 W h/L to be achieved, depending on the electrochemical couple used, and specific design parameters, as discussed below. Microbatteries of this form could be used to power a wide variety of small systems from simple sensors to systems with integrated ultrahigh density packaging.

A microfabricated structure of 3D electrode arrays is co-fabricated with an integral hermetic package, e.g., as is illustrated in FIGS. 6A-6E. This particular demonstration uses graphite and laser micromachining as the fabrication method. Using highly-oriented pyrolytic graphite (HOPG) that was laser-machined to about 200 micrometer half-thickness, cycling rates of about C/20 were demonstrated in lithium half-cells. In graphite, a ten-fold increase in rate to 2 C would require a factor of 10^{1/2}=3.2 reduction in cross-sectional dimension (e.g., diffusion time t=x²/D, where x is the diffusion length and D the diffusion coefficient). These dimensions are achievable with laser micromachining technology. In order to maximize energy density, the electrode cross-sectional dimensions should be as large as possible while still supplying the desired rate capability (since the inactive materials fraction increases as the feature size decreases). In some microbattery applications, electrodes having micrometer to tens of micrometer dimensionality may be sufficient.

FIG. 6A shows that laser micromachining can produce individual electrode features in graphite having about 50 micrometer half-thickness and 0.5 mm height with a slight (controllable) taper, forming a 3 mm×3 mm array (4.5 mm³ volume). Furthermore, the lateral resolution and taper of the kerf in laser machining is strongly impacted by the thermal conductivity of the material being machined, with high thermal conductivity decreasing resolution and increasing taper. In lithium intercalation oxides of low thermal conductivity compared to graphite, it is expected that closely-spaced features of about 10 to about 20 micrometer total width to be possible at feature heights of about 0.5 mm to about 1 mm. In this example, 3-dimensional (3D) electrodes of similar morphology but having smaller cross-sections can be fabricated from lithium storage compounds, by laser-micromachining or other microfabrication processes, for example, amenable to simultaneous fabrication of many devices. These continuous and dense 3D electrode arrays can be fabricated from the active material of lower electronic conductivity, usually the cathode, in order to decrease electronic polarization and increase the rate capability of the final device.

Using the microfabricated electrode/package structures as the starting template, three example paths to fabrication of the completed battery are demonstrated, with reference to FIG. 11, as discussed below.

In one path, conformal deposition of a solid inorganic electrolyte film (e.g., LiPON) is performed by sputtering, which can create an electronically insulating layer of 1 micrometer to 3 micrometer thickness, which may cover the upward-facing surfaces. The taper of these electrode features can be “tuned” through instrumental parameters to allow conformal coating. At such thickness, the impedance of the electrolyte film during subsequent use as a battery may be low enough that the rate capability can be primarily determined by the electrodes. After electrolyte deposition, the remaining free volume within the cell can be filled by the counterelectrode. The counterelectrode will, in one instance, be Li or a Li alloy, melt-infiltrated (about 180° C.) into the coated electrode array using a “flux and solder” process to enable high surface tension liquid lithium to wet oxide surfaces, as discussed above. An advantage of using lithium metal is that its high volumetric capacity allows the negative electrode to be of small volume, for example only about one-fourth that of the positive electrode, if LiCoO₂ is used. Thus, a negative electrode film of only several micrometer dimensions filling the pore space of the electrode array may be needed for cell balancing. Alternatively, the counterelectrode can be applied in the form of a powder suspension where a solid polymer electrolyte (e.g., PEO-based) is included in the formulation to provide a fully solid-state device. Subsequently, a top current collector can be applied by physical vapor deposition or thick film paste technology, following which a hermetic sealing layer including a sputtered oxide or CVD-applied polymer layer (parylene) is used to complete the packaging.

In another path, similar to the path outlined above, the electrolyte film is an electrodeposited layer of a solid polymer electrolyte. Methods for the electrodeposition of electronically insulating polymer films can be applied in this project to form electrolytic layers. Alternatively, a layer-by-layer deposition approach may be used. The counterelectrode may be powder suspension based, since even the modest melting temperature of Li alloys could damage polymeric electrolytes. The subsequent packaging steps are similar as described above.

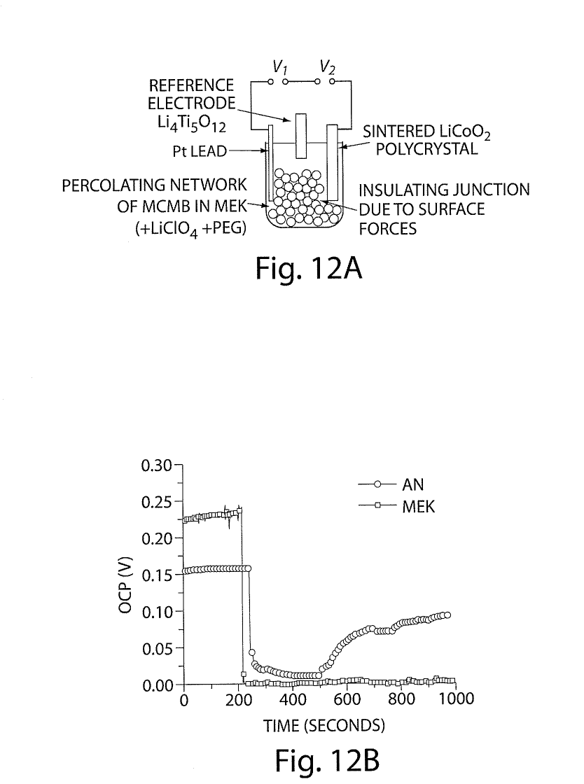

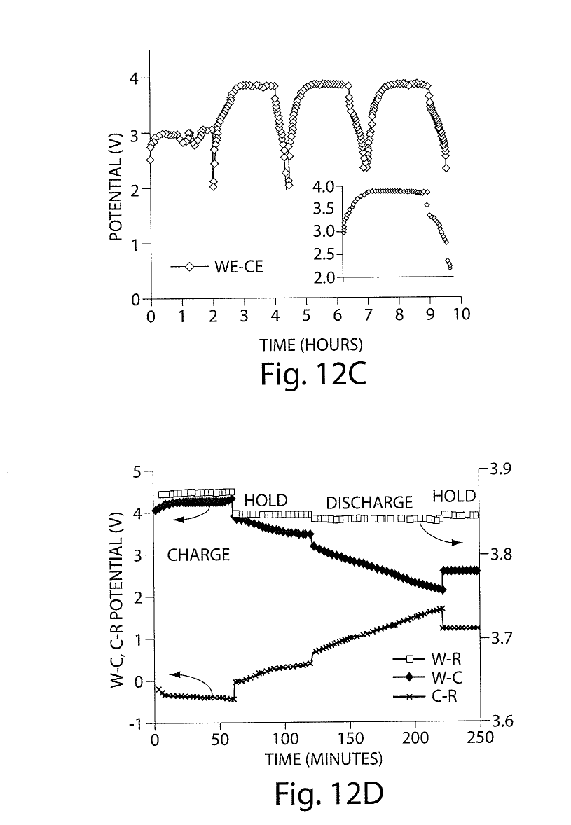

In yet another path, a colloidal-scale self-organization approach may be applied. LiCoO₂ and graphite immersed in a suitable solvent may be mutually repulsive due to short-range dispersion and electrostatic forces. FIGS. 12A-12D shows key results in which the mutual repulsion between sintered dense LiCoO₂ and an MCMB (mesocarbon microbead) suspension formed a rechargeable lithium battery under the influence of the surface forces. The constituents of solid polymer electrolytes were dissolved in the solvent without negatively affecting the interparticle forces. FIG. 12A shows a cell schematic. FIG. 12B shows the open circuit potential (OCP) between LiCoO₂ and MCMB upon forced contact, showing an electrical short-circuit upon contact for acetonitrile, but an open circuit for MEK (methyl ethyl ketone) due to repulsive surface forces. FIG. 12C shows reversible galvanostatic cycling of a self-organized battery using MEK and 0.1 M LiClO₄ as the electrolyte. FIG. 12D shows measurements of the potential difference between a Li titanate reference electrode and the LiCoO₂ working (W) and MCMB counter (C) electrodes, conducted in MEK and 0.1 M LiClO₄ and 1 wt % PEG 1500 (poly(ethylene glycol)). All potentials referenced to Li/Li⁺. Potentials observed during each stage of the test demonstrate Faradic activity, with the LiCoO₂ being delithiated and MCMB being lithiated. In the present configuration, an MCMB suspension can be used to fill the integral container formed from the LiCoO₂ and a self-forming separator obtained upon drying. Subsequent application of a top current collector and outer packaging will be carried out in the same manner as the above.

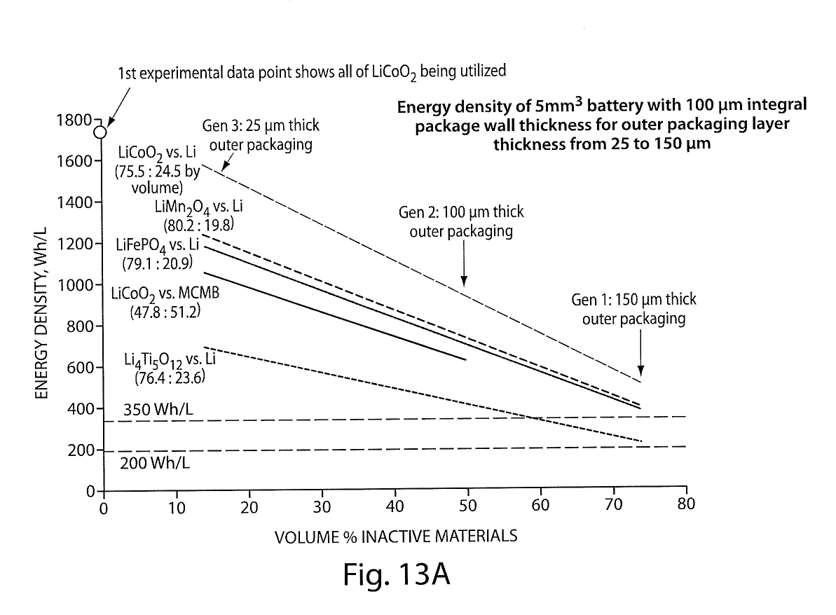

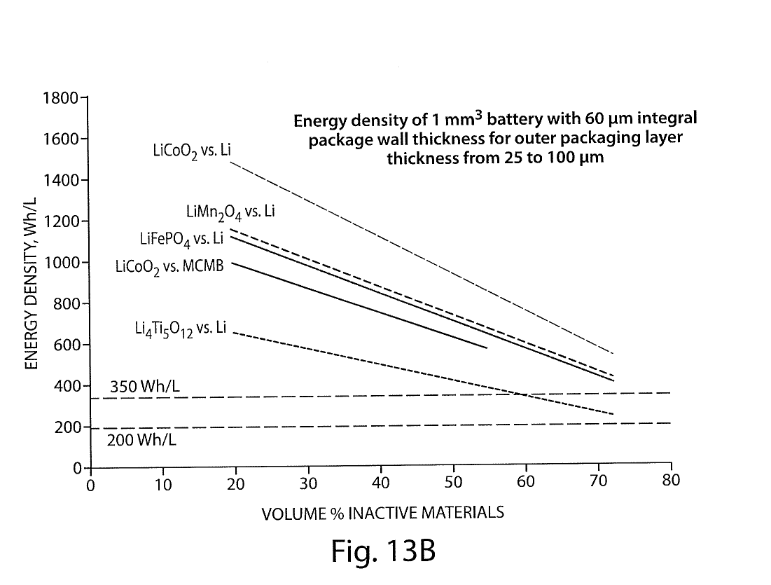

The energy densities are determined in these devices by the volume fraction of active materials present in the cell, and the degree of electrochemical utilization of those materials. In FIGS. 13A and 13B, plots of the expected energy density for microbatteries made from 5 different electrochemical couples using the present fabrication approach is plotted against the volume fraction of inactive material in the packaged cell due to the electrolyte layer, integral package wall, current collectors, and outer packaging for 5 mm³ (FIG. 13A) and 1 mm³ (FIG. 13B) volumes. In each case, the relative volumes of the positive and negative electrode are as needed for a charge-balanced cell. The theoretical energy density (at zero percent inactive material) of these systems exceeds 350 W h/L by a factor of 2.3 to 5. The results for 5 mm³ microbatteries of the configuration in this example are calculated assuming realistic component dimensions: 50 micrometer electrode diameter with 100 micrometer or 60 micrometer integral package wall thickness, 2 micrometer electrolyte layer thickness, and 10 micrometer thick current collectors. The thickness of the outer packaging is treated as a variable, ranging from 25 micrometer to 150 micrometer thickness. Also shown in FIG. 13A is an experimental data point (identified as 21), which illustrates that substantially all of the LiCoO₂ has been utilized.

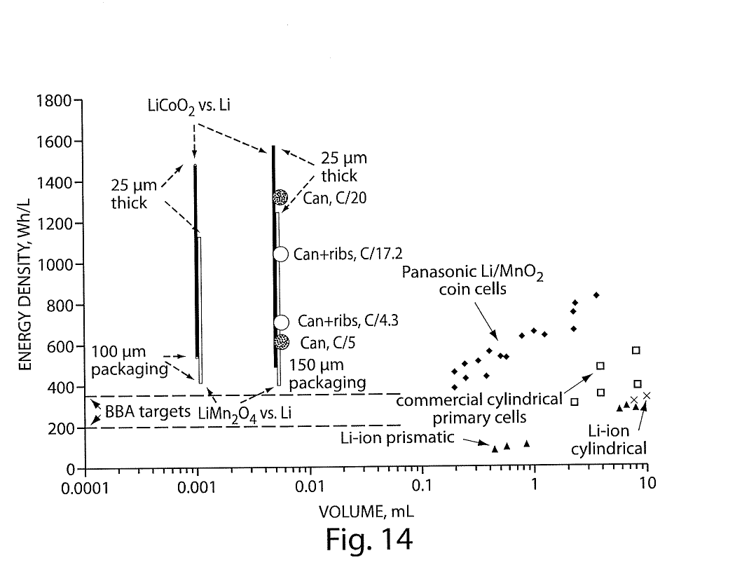

FIG. 14 compares the results in FIGS. 13A and 13B against recent data for commercially-available small batteries, as well as data for various embodiments of the invention at various discharge rates. Based on this figure, the performance envelope represented by this approach appears to represent a major improvement in the performance of small batteries.

### EXAMPLE 2

In this example, 3D batteries having periodic or aperiodic interpenetrating electrodes are used since their electronic conductivity is typically higher than ionic conductivity in battery materials. Interpenetrating electrodes of high aspect ratio can have shorter ion diffusion length between electrodes while still taking advantage of the higher electronic conductivity along the electrodes to extract current. In the solid-state diffusion limit, the dimension that may determine the utilization of the battery capacity is the half-width x of the electrode features, for which the discharge time is t=x²/D_{Li}.

Using tabulated room-temperature lithium chemical diffusivities (D_{Li}) for spinel and layered structure intercalation oxides, which fall in the range 1×10⁻⁹ cm²/sec to 5×10⁻⁹ cm²/sec, for a maximum 2 C discharge rate (t=1800 sec), a half-thicknesses of about 6 to about 30 micrometers is useful. These kinetics and their limitations on particle dimensions are well-known to the battery field; LiCoO₂ is typically used as particles of 5 to 10 micrometers dimension, while LiMn₂O₄ has a higher and also isotropic lithium diffusion coefficient allowing roughly 25 micrometer particles to be used. LiFePO₄, on the other hand, has a much lower lithium diffusion coefficient requiring particle dimensions of <100 nm for high energy and power. Li₄Ti₅O₁₂ is similar to LiFePO₄ in this respect. Such materials may be used as fine-scale porous materials filled with suitable electrolytes. For LiCoO₂ and LiMn₂O₄, as well as related layered oxide and spinel compounds, a total electrode dimension of 10 micrometers to 30 micrometers may be desired. Also, for any reticulated structure, the smaller the feature size, the greater the inactive volume occupied by electrolyte/separators, binders and/or conductive additives. The results plotted in FIGS. 13 and 14 show that these materials, combined with a low lithium potential anode such as Li metal, Li alloys, or carbon-based electrodes, have desirable energy densities at the proposed electrode dimensions.

For non-planar form factors, a second issue in the fabrication of microbatteries is the electrode aspect ratio or feature height. While various lithography-based processes have been used recently to fabricate 3D electrodes, these experiments focus on laser micro-machining due to its suitability for fabricating highly aspected features with controlled taper. FIG. 4 illustrates these two geometric parameters, as well as the ability to design in controlled pore fraction for the counterelectrode. FIG. 4A shows 1.2 mm height at 200 micrometer to 250 micrometer feature width; FIGS. 4B and 4C illustrate the ability to control taper. As mentioned earlier, the spatial resolution of laser-micromachining can be determined by the thermal conductivity of the material. Preliminary laser-machining results on densified LiMn₂O₄ as one example indicates that it is possible to fabricate 3D electrodes having 5:1 to 20:1 aspect ratios at the cross-sectional dimensions desired.

Too high of an aspect ratio may be undesirable in some cases from the viewpoint of electronic polarization (voltage drop along the electrode), for example, in highly reticulated electrodes of thin cross-section. For LiCoO₂ and LiMn₂O₄ and related compositions, which have electronic conductivities>10⁻³ S/cm at room temperature, the voltage drop at these aspect ratios is negligible (<0.1 V).

While laser-machining with a single focused beam is one approach, resulting in individually fabricated devices, scale-up to fabrication methods capable of producing many simultaneous devices from an oxide “wafer” (e.g., produced by hot-pressing) is also possible. Laser-machining remains an option for scaleup, using diffuse beams and physical masks, for example. However, other methods used in MEMS fabrication such as deep reactive ion etching are also possible.

The electrolyte layer may be LiPON. LiPON is a thin film electrolyte, which at 1 micrometer to 2 micrometers thickness provides a low impedance, high rate, low self-discharge electrolyte. The fabricated 3D electrode structures can be sputtered with LiPON. The uniformity of LiPON coverage can be evaluated by electron microscopy and electrical tests after deposition of the counterelectrode.

An alternative to LiPON is the electrodeposition of solid polymer electrolytes (SPEs) such as PEO-based compositions, or a polyelectrolyte multilayer approach. Recent work on electrophoretically formed batteries shows that electrodeposition is an effective conformal deposition technique for PEO-based electrolytes. For typical room temperature conductivities of 10⁻⁵ S/cm to 10⁻⁴ S/cm, the electrolyte is not limiting, at a few micrometers thickness.

Selection and deposition of the counterelectrode may be performed as follows. 3D micromachined structures may be formed out of the positive electrode for electronic conductivity reasons discussed earlier. For the negative electrode that will fill the pore space after deposition of the electrolyte film, lithium metal, a lithium metal allow such as LiAl, or a graphite-based suspension can be used, with a cell structure designed to achieve cell balance. Graphite based anodes such as MCMB can be formulated similarly to conventional lithium ion anodes, except that in the absence of liquid electrolytes, SPE can be used as a binder phase. These suspensions can be used to infiltrate the pore space in the electrolyte-coated 3D structure.

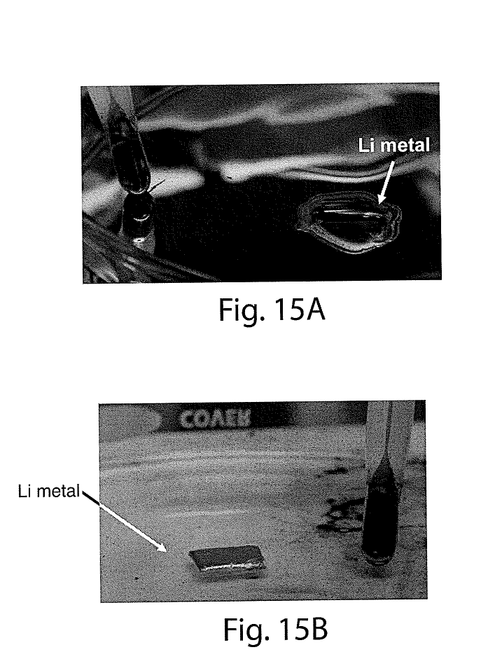

For the deposition of 0.5 mm to 1 mm thick lithium metal, given the low melting point (181° C.) of lithium metal, it would be attractive to use liquid metal infiltration to fill the 3D structure. A difficulty is that, like other liquid metals, lithium has a high surface tension and does not as easily wet oxides or polymers. Thus, a “flux and solder” method is used in this example, by which liquid lithium can be made to wet oxide surfaces. By first sputtering a thin layer of a metal that alloys with Li, such as Au, reactive wetting of the sputtered surface occur readily. This was demonstrated on glass surfaces, as shown in FIG. 15, with various configurations and various discharge rates. Thus, a sputtered metal layer applied to the electrolyte surface can be used to enable subsequent infiltration by lithium metal, filling the 3D electrode structure (FIG. 11). In order to control the amount of lithium metal that is deposited, the liquid lithium may be dispensed through a syringe or to dispense and then melt the solid lithium metal powder (SLMP) available from FMC corporation, which is passivated with a surface phosphate layer to allow handling in air and certain organic solvents.

Self-organization as an assembly method may also be used for selection and deposition of the counterelectrode. A colloidal-scale self-assembly method for bipolar-devices may be used in which repulsive forces between dissimilar materials are used to form electrochemical junctions at the same time that attractive forces between like material are used to form percolating conductive networks of a single electrode material. A demonstration of this approach is shown in FIG. 12, in which the percolating network is MCMB. The present 3D forms a dense and continuous 3D electrode from the less conductive material.

One of the challenges in microbattery technology, including thin-film batteries, has been the development of effective hermetic packaging with minimal contributed volume. The 3D design in this example uses densified oxide for hermetic sealing on all except the top surface (FIG. 11). Thus final sealing of the battery can be accomplished by deposition from the top of a suitable packaging material. A parylene-based packaging material, on top of which is typically sputtered a metal film for hermeticity may be used, or a dense insulating oxide coating by physical vapor methods may also be used.

### EXAMPLE 3

In this example, it is shown that a porous sintered electrode of LiCoO₂ of greater than 0.5 mm minimum cross-sectional dimension that is infused with a liquid electrolyte can, surprisingly and unexpectedly, be electrochemically cycled while obtaining nearly all of the available ion storage capacity over at least 20 cycles at C/20 rate with minimal capacity fade and no apparent detrimental mechanical damage to the electrode. This shows that such electrodes can effectively be used in certain batteries of the invention.

A battery grade LiCoO₂ powder from Seimi Corporation (Japan) having 10.7 micrometers d₅₀ particle size was pressed and fired at 1100° C. in air to form a porous sintered ceramic having about 85% of the theoretical density of LiCoO₂. In one instance, a plate of this electrode having 0.66 mm thickness was prepared, as shown in FIGS. 8A and 8B. This electrode plate was attached to a gold foil current collector and assembled for testing in a sealed polymer pouch-cell, using lithium metal foil as the counterelectrode, a copper current collector at the negative electrode, a porous polymer separator of 20 micrometer thickness, and a liquid electrolyte having a 1.33 M concentration of LiPF₆ in a mixture of alkyl carbonates.

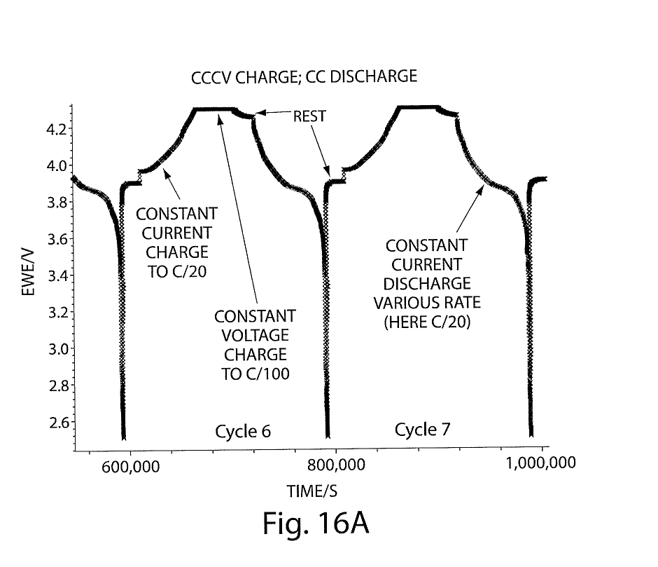

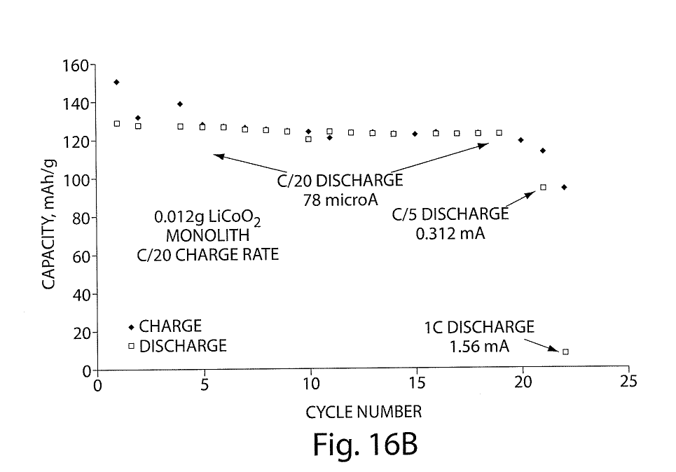

FIG. 16A shows the 6^{th} and 7^{th} charge-discharge cycles of this cell. The charge protocol used a constant current at C/20 rate to an upper voltage of 4.3 V, followed by a constant voltage hold until the current decayed to C/100 rate, followed by an open-circuit rest, followed by a constant current discharge to 2.5 V. FIG. 16B shows the charge and discharge capacities observed over 20 cycles at C/20 discharge rate, followed by discharges at C/5 and 1 C rate. The C/20 discharge capacity was about 130 mAh/g, essentially the same as the value observed for this LiCoO₂ over this voltage range in standardized tests. This shows that this porous electrode was able to accept and discharge nearly all of the lithium storage capacity at C/20 rate. Even at C/5 rate, the capacity was above 90 mAh/g. Furthermore, there was very little capacity fade over 20 cycles at C/20 rate. When this electrode is packaged as a complete microbattery according to the earlier described construction and methods, the volume is 6.4 mm³ and the projected energy density based on the measured cathode performance is 954 W h/L.

Remarkably, this sample was found to exhibit no apparent signs of mechanical failure after this electrochemical test, as shown in FIG. 9.

In other instances, the electrodes shown in FIGS. 2 and 7 were produced from the same starting sintered ceramic using laser micromachining, and were assembled into a test cell and electrochemically tested in the same manner. These test electrodes exhibited similar electrochemical performance to the electrode of FIG. 16. Based on the electrochemical tests of each of these electrodes, in fully packaged form, the electrode of FIG. 2 produces a battery of 5.72 mm³ volume and 1022 W h/L energy density, while the electrode of FIG. 7 produces a battery of 5.74 mm³ volume and 1300 W h/L.

### EXAMPLE 4

In this example, it is shown that a porous sintered electrode of a lithium transition metal phosphate olivine that is infused with a liquid electrolyte can, surprisingly and unexpectedly, be electrochemically cycled while obtaining nearly all of the available ion storage capacity over at least 30 cycles at C/10 rate with minimal capacity fade. This shows that such electrodes can effectively be used in certain batteries of the invention.

A powder of a Nb-doped, nanoscale lithium iron phosphate material such as is described in U.S. patent application Ser. No. 10/329,046, filed Dec. 23, 2002, entitled “Conductive Lithium Storage Electrode,” by Chiang, et al., published as U.S. Patent Application Publication No. 2004/00055265 on Jan. 8, 2004 (incorporated herein by reference), was uniaxially pressed into a ½ inch disk at a pressure of 20,000 psi (1 psi=6.89475 kilopascals) and sintered in a tube furnace at 775° C. for 2 hours in Ar atmosphere.

After sintering, the material was observed using scanning electron microscopy to have a primary particle size of 100-200 nm. The density of the disk was measured to be 72% by the Archimedes method. The disk was polished to 0.305 mm thickness using 5 micron grit size silicon carbide polishing paper and cut using a diamond wire saw to a rectangular dimension of 3.48 mm by 2.93 mm by 0.305 mm. The sample weight was 7.3 mg. The sample was assembled as the positive electrode in an electrochemical test cell made using Swagelok fittings using 150 micrometer Li foil ( 7/16″ inch in diameter) as both the counter and reference electrode. Celgard 2320 (½″ inch in diameter) was used as the separator. A liquid electrolyte having a 1.33 M concentration of LiPF₆ in a mixture of alkyl carbonates was used. The cell was galvanostatically charged at C/20 for the first cycle and at C/10 for all the subsequent cycles. All the discharge rates are C/10 unless otherwise indicated. The voltage window was between 2 and 4.2 V.

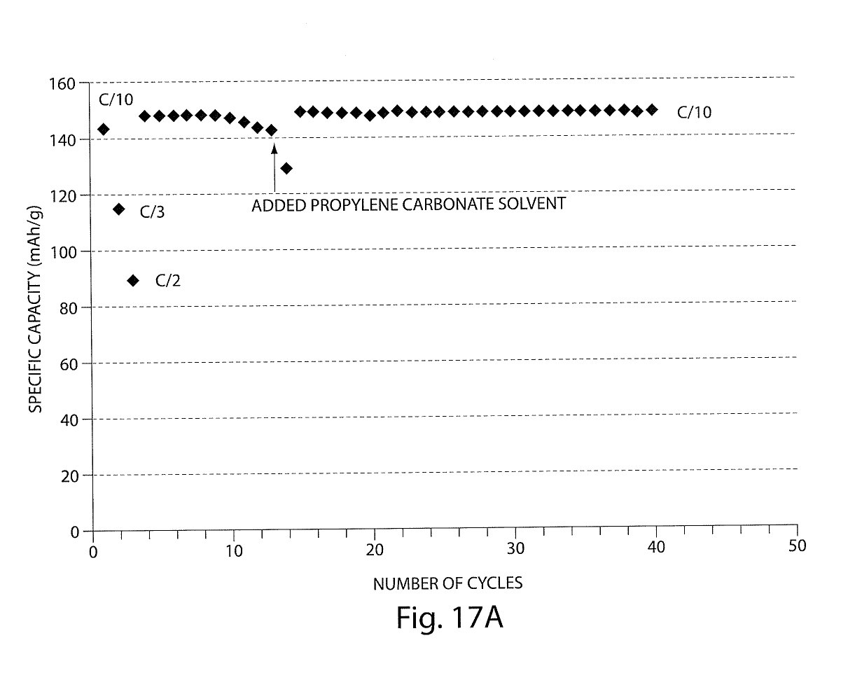

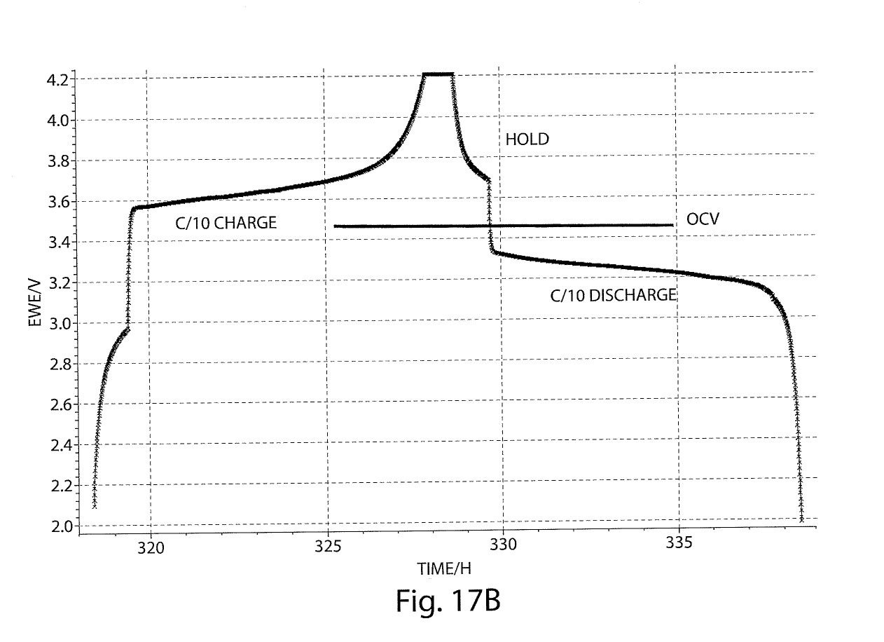

FIG. 17A shows the specific capacity as a function of cycle number for the cathode, which comprised sintered doped olivine phosphate, and shows that almost no capacity fade occurred over 40 cycles. FIG. 17B shows voltage vs. time of the 30^{th} galvanostatic charge/discharge cycle of the cathode. The cathode had a density of 72% and was 0.305 mm thick. These results demonstrate that the sintered cathodes of the invention can be usefully employed in the batteries of the invention.

### EXAMPLE 5

This example demonstrates a sintered porous electrode onto which is conformally deposited a dense solid electrolyte film and that it can be used as an electrode in the batteries of certain embodiments of the invention. LiCoO₂ powder with a mean particle size of 10-11 micrometers was purchased from a commercial vendor. 35 g of the powder was milled for 5 days in a zirconia jar mill using zirconia milling balls. After milling, the mean particle diameter fell to 4-5 micrometers. 3.5 g of the milled powder was pressed into a ½-inch diameter pellet (about 1.27 cm) under a pressure of 100 MPa in a uniaxial press. The pellet was placed onto an alumina plate, covered with loose LiCoO₂ powder, covered by an inverted alumina jar and sintered under air for 1.5 hrs at 950° C. The densified cylindrical pellet was recovered and sliced into 0.8 mm thick disks.

One of the LiCoO₂ disks was simultaneously thinned down to 0.4-0.5 mm thickness and polished to a mirror-like finish using silicon carbide abrasive pads of increasingly finer grit size down to 1.0 micrometer. The disk was affixed onto an alumina plate and diced into 2.2 mm×2.2 mm squares. The squares were mounted into a metallic fixture and placed into a custom-built vacuum deposition chamber. In several hours, the exposed top surface of each square was coated with an ˜0.5 micrometer thick lithium phosphorous oxynitride (LiPON) coating that was also visible to the eye by its iridescence. The coated electrode was assembled and tested in an electrochemical cell as described in Example 4.

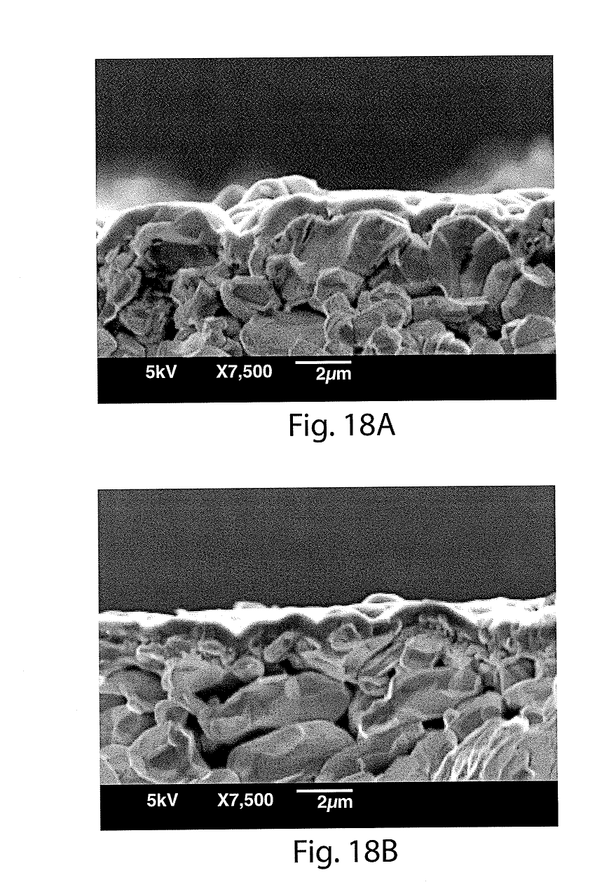

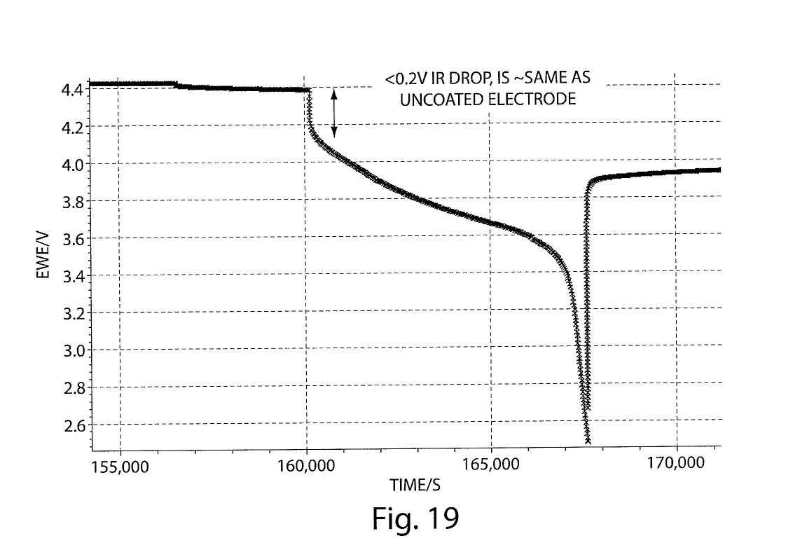

FIG. 18 shows a scanning electron microscope image showing the continuous, conformal LiPON coating. FIG. 19 shows that in galvanostatic cycling, such a film presented very little additional resistance compared to an uncoated electrode.

### EXAMPLE 6

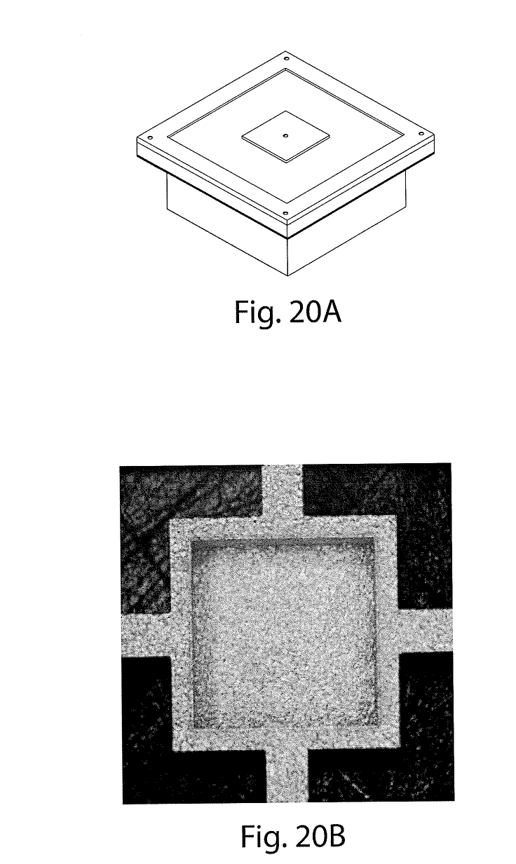

This example demonstrates high energy density packaged microbatteries made using certain sintered porous electrodes of the invention. Two microbatteries are described in this particular example, made using the following procedure. A sintered porous LiCoO₂ electrode (2.20 mm by 2.20 mm by 0.37 mm), made as described in Example 3, was put into a electroformed gold can (2.5 mm by 2.5 mm by 0.7 mm), shown in FIG. 20, using a conductive paste made of polyvinylidene fluoride (PVDF), vapor grown carbon fibers (VGCF), and high surface area carbon black. A Celgard 2320 separator was glued onto the flange of the can on three sides using a visible light curable glue, Loctite 3972. A small piece of Li was put on a 10 micrometer thick copper foil lid cut to fit on top of the can, and heated at 100° C. for 20 minutes. Four holes were punched around the Li using a small needle to allow for subsequent infiltration by liquid electrolyte. The copper foil lid, with the lithium metal negative electrode facing the open top of the can, was glued onto the separator using Loctite 3972 on the same three. The whole cell was immersed in a liquid electrolyte, of the kind described in Example 3, for 24 hours and then was galvanostatically charged to 4.6 V at a C/12 rate and discharged at a C/2.7 rate to 3V.

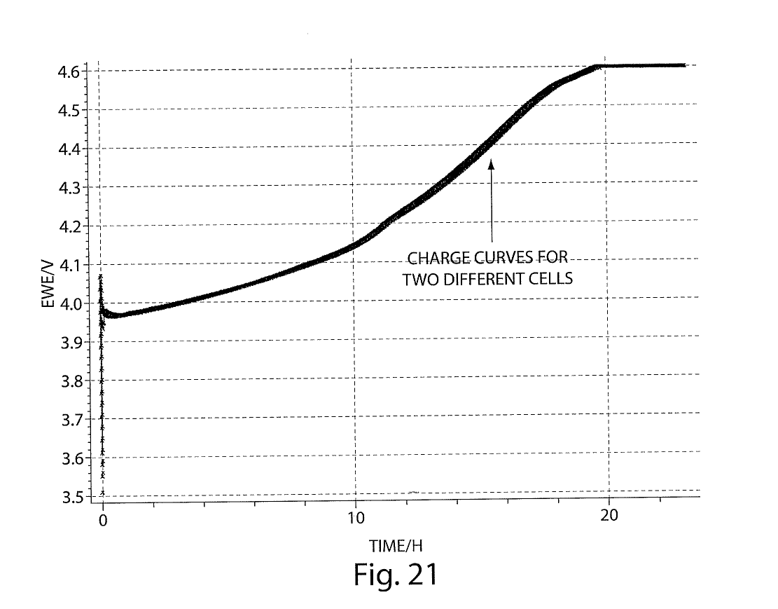

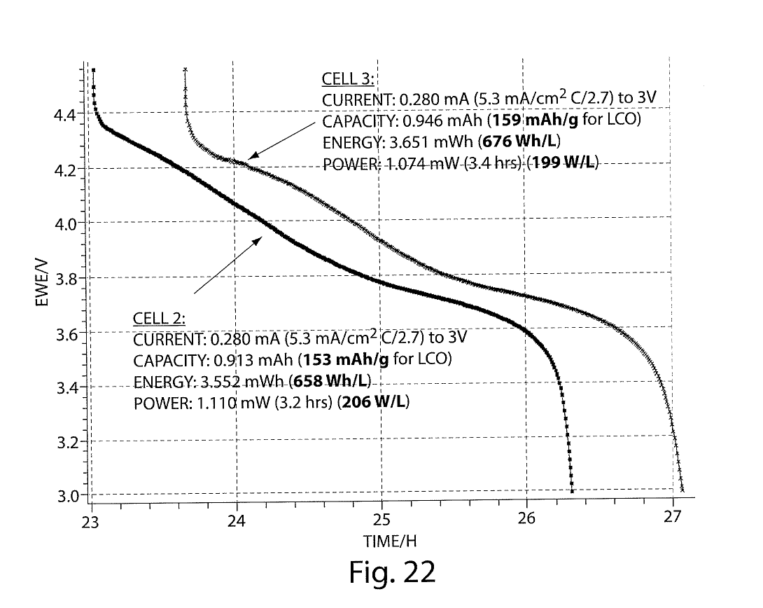

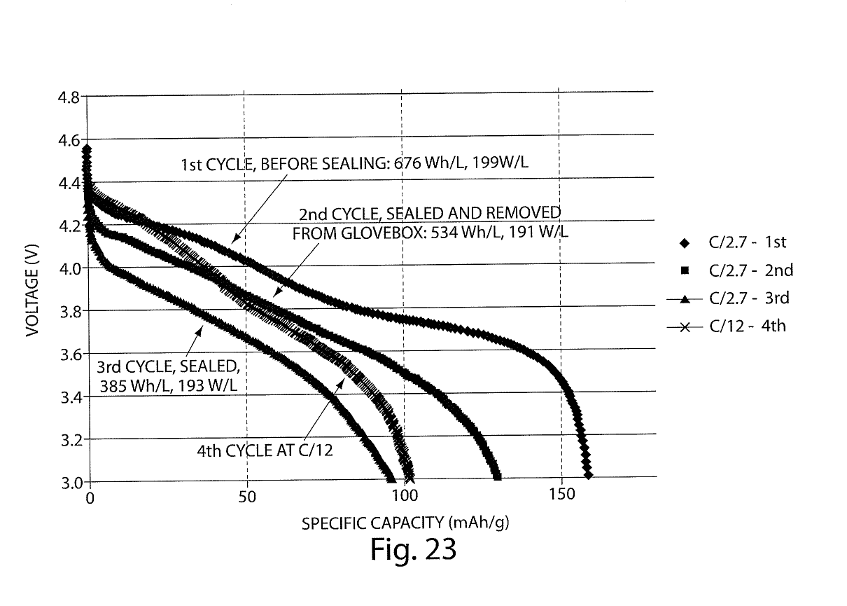

FIG. 21 shows that both cells can be charged smoothly to 4.6V. FIG. 22 shows that in the first discharge, both cells exhibited high energy densities of 676 W h/L and 658 W h/L respectively, at about 200 W/L power. After the first cycle, excess electrolyte was cleaned from the surface of the cell and the electrolyte infiltration holes were sealed using Loctite 3972. The cell was then sealed on all its surfaces with Hardman fast-setting 3 minute epoxy and tested further. FIG. 23 shows the specific capacity of the cathode during the first 4 cycles of one of the cells. In the second and third discharges under the same current as the first cycle, the capacity and energy had decreased, but remained still very high. The 4^{th} cycle was conducted at a C/12 rate, and shows that the cell had diminished in its capacity to about 100 mAh/g. This behavior corresponds to the behavior reported in the literature for LiCoO₂ charged to 4.6 V, and shows that the sintered cathode in the microbatteries of the invention can be used to prepare high energy density microbatteries.

### EXAMPLE 7

This example demonstrates a high energy density bicell battery made according to certain embodiments of the invention. Sintered LiCoO₂ electrodes were made according to the method of Example 5 and sliced into two 0.8 mm thick disks that were then thinned down to 0.4 mm thickness and polished to a mirror-like finish using silicon carbide abrasive pads of increasingly finer grit size down to 3 micrometers.

Aluminum current collector strips with a wide end size matched to the circular LiCoO₂ was cut out of 35 micrometer thick aluminum foil. The wide ends were coated with a thin layer of a conductive paste made of polyvinylidene fluoride (PVDF), vapor grown carbon fibers (VGCF), and high surface area carbon black. The LiCoO₂ disks were attached to the current collector strips using the conductive paste. The strips were air dried for an hour first and then vacuum-dried for 12 hours at 90° C. After drying, the LiCoO₂ disks were found to be bonded well to the aluminum strip. The end of the strip with the attached LiCoO₂ disks was soaked in a liquid electrolyte mixture for 12 hours to ensure infiltration.

Lithium negative electrodes were cut from a 150 micrometer-thick lithium sheet to match the size of the disk cathodes. These lithium pieces were pressed onto two sides of a 10 □m thick copper foil, serving as the negative current collector.

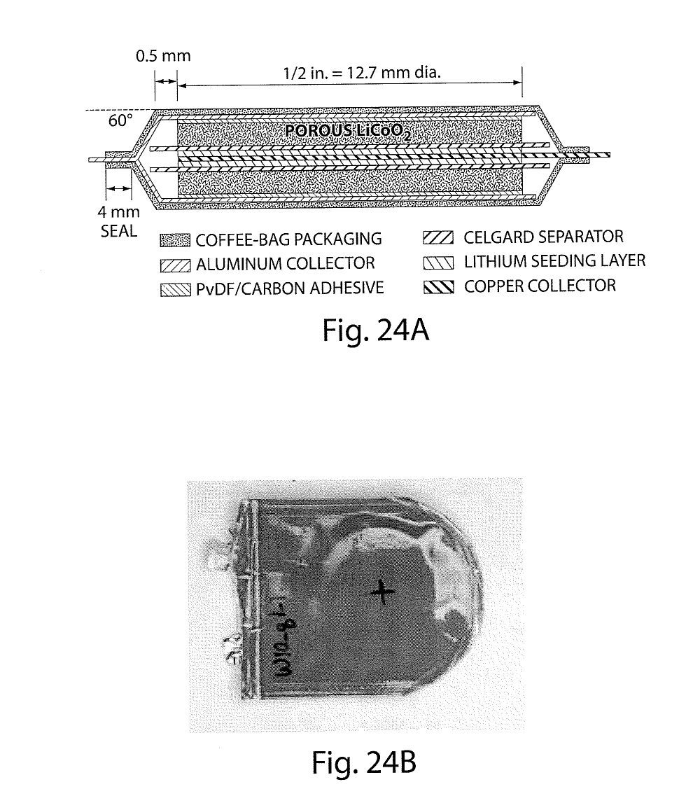

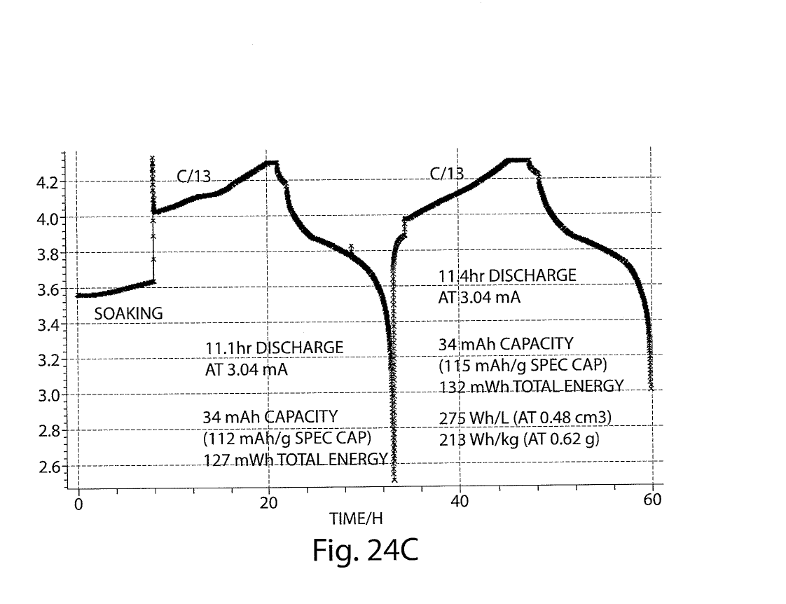

An electrochemical bicell as illustrated in FIGS. 24A-24C was constructed from the positive and negative electrodes, with a layer of Celgard 2320 separator separating the two, and polymer packaging heat-sealed around the electrode assemblies. Some additional liquid electrolyte was added to the cell before vacuum sealing. FIG. 24 shows that the bicell could be charged and discharged between 4.3 V and 2.5 V, but exhibited a high energy density and specific energy compared to other lithium ion cells of comparable size (e.g., about 0.5 cm³ volume), of 275 W h/L and 213 W h/kg respectively.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. The article of claim 154,
wherein the electrode is a sintered ceramic.

2. The article of claim 1,
wherein the sintered electrode is a ceramic composite.

3. The article of claim 154, wherein the polymer is a block copolymer.

4. (canceled)

5. The article of claim 154, wherein the electrode has a linear strain differential of less than about 20% when the electrode is infiltrated with Li ions.

6-7. (canceled)

8. The article of claim 154, further comprising a nonporous electrolyte disposed on the electrode.

9-11. (canceled)

12. The article of claim 154, wherein the ceramic comprises LiCoO₂.

13. (canceled)

14. The article of claim 154, wherein the electrolyte filling the pores comprises LiPF₆.

15. The article of claim 154, wherein the electrolyte filling the pores comprises polyethylene oxide.

16. The article of claim 154, wherein the nonporous electrolyte comprises lithium phosphorous oxynitride.

17. The article of claim 154, wherein the article is a battery.

18-21. (canceled)

22. The article of claim 154, wherein the electrolyte is a polymer electrolyte.

23. The article of claim 154, wherein the electrolyte is a deposited film.

24. (canceled)

25. The article of claim 154, wherein the ceramic has a surface and a bulk, the surface having a lower porosity than the bulk.

26-32. (canceled)

33. The article of claim 154,
wherein the article is a battery having a volume of no more than about 10 mm³ and an energy density of at least about 200 W h/l.

34-41. (canceled)

42. The article of claim 154, wherein the ceramic has a smallest dimension that is at least about 0.2 mm.

43-105. (canceled)

106. The article of claim 154,
wherein the electrode has a base and a plurality of protrusions extending at least about 50 micrometers away from the base of the electrode, substantially all of the protrusions having a surface and a bulk and being sized such that substantially all of the bulk is no more than about 25 micrometers away from the surface; and
wherein the electrolyte is nonporous and disposed on the surfaces of the protrusions.

107. (canceled)

108. The article of claim 106, wherein substantially all of the protrusions are sized such that substantially all of the bulk is no more than about 10 micrometers away from the surface.

109. (canceled)

110. The article of claim 154,
wherein the electrode comprises a base and a plurality of protrusions extending from the base, and a wall extending from the base and surrounding the plurality of protrusions, the protrusions and the wall formed from a unitary material.

111. The article of claim 110, wherein the electrode is able to retain at least about 50% of its initial storage capacity after at least 6 charge-discharge cycles at a C/20 rate.

112. The article of claim 110, wherein the ceramic has a linear strain differential of less than about 20%.

113. (canceled)

114. The article of claim 110, wherein the electrode comprises LiCoO₂.

115-133. (canceled)

134. The article of claim 154,
wherein the electrode has a plurality of protrusions, the protrusions having an aspect ratio of at least about 3:1 and a pitch of at least about 2:1, the electrode being formed from a unitary material.

135-147. (canceled)

148. An article, comprising:
a metal or metalloid electrode;
a nonporous electrolyte contacting the electrode; and
a porous sintered electrode contacting the nonporous electrolyte.

149. The article of claim 148, wherein the electrode comprises lithium.

150-152. (canceled)

153. The article of claim 148, wherein the electrode comprises one or more metals or metalloids selected from the group consisting of B, Al, Ag, Au, Bi, Ge, Sn, Si, and/or Zn.

154. An article, comprising:
an electrode comprising a ceramic, the electrode having a void volume of no more than about 50%, at least some of the pores of the electrode being filled with an electrolyte that is a liquid or a polymer.

155. The article of claim 154, wherein the ceramic comprises LiMO₂, wherein M is at least one transition metal.

156. The article of claim 154, wherein the ceramic comprises LiMPO₄, wherein M is at least one transition metal.

157. The article of claim 106, wherein at least some of the protrusions comprises LiCoO₂.

158. The article of claim 106, wherein at least some of the protrusions comprises LiMO₂, wherein M is at least one transition metal.

159. The article of claim 154, wherein the pores are formed by removing a fugitive material from the electrode.

160. The article of claim 154, wherein the ceramic comprises Li⁺.

161. The article of claim 154, wherein the article is a lithium ion battery.

162. The article of claim 154, wherein the article is a disposable battery.

163. The article of claim 154, wherein the article is a rechargeable battery.

164. The article of claim 154, wherein the electrode comprises an alkali ion.

165. The article of claim 154, wherein the electrode comprises a transition metal.

166. The article of claim 154, wherein the electrode comprises lithium transition metal oxide.

167. The article of claim 154, wherein the electrode comprises lithium transition metal phosphate.

168. The article of claim 154, wherein the article further comprises a second electrode formed from graphite.

169. The article of claim 154, wherein the article further comprises an electrode formed from intercalation oxide.

170. An article, comprising:
an electrode formed by removal of a fugitive material from an electrode precursor.

171. The article of claim 169, wherein the fugitive material removed from the electrode precursor comprises a solid.

172. The article of claim 169, wherein the fugitive material removed from the electrode precursor comprises ice.

173. The article of claim 169, wherein the fugitive material removed from the electrode precursor comprises naphthalene.

174. The article of claim 169, wherein the fugitive material removed from the electrode precursor comprises latex spheres.

175. The article of claim 169, wherein the fugitive material removed from the electrode precursor comprises polymer fibers.

176. The article of claim 169, wherein the fugitive material removed from the electrode precursor comprises a carbonaceous material.
